(19) United States
(12) Patent Application Publication
(10) Pub. No.: US 2025/0013986 A1
(43) Pub. Date: Jan. 9, 2025

(54) SYSTEM AND METHOD FOR INTEGRATING GLOBAL WARMING POTENTIAL OF CONSTRUCTION ACTIVITIES WITH CRITICAL PATH METHOD SCHEDULES

(71) Applicant: JCMS, INC., MERCERVILLE, NJ (US)

(72) Inventors: Achintyamugdha Surendra Sharma, Hamilton, NJ (US); Priyanka Deka, Hamilton, NJ (US); Goutam Umesh Jois, Summit, NJ (US); Umesh Krishnamurthy Jois, Plainsboro, NJ (US); Pei Tang, Princeton, NJ (US)

(73) Assignee: JCMS, INC., MERCERVILLE, NJ (US)

(21) Appl. No.: 18/748,436

(22) Filed: Jun. 20, 2024

Related U.S. Application Data
(60) Provisional application No. 63/521,995, filed on Jun. 20, 2023.

(51) Int. Cl. G06Q 10/10; G06Q 50/08

(52) U.S. Cl. CPC G06Q 10/103; G06Q 50/08

(57) ABSTRACT

A computer-implemented critical path method (CPM) scheduling system and method integrates carbon emissions associated with construction activities and permits a user to schedule a construction project including those activities. Information is stored regarding one or more milestones, phases, and activities associated with the project. The activity information includes interdependency and carbon emissions information associated with the activity. Based on the milestone information, phase information, and activity information, one or more of the following is calculated: a project schedule; identification, duration, date, and total carbon emission information for key activities; duration, date, and total carbon emission information for phases; and date and total carbon emission information for milestones.

### CROSS-REFERENCE TO RELATED APPLICATIONS

The present application claims priority to U.S. provisional patent application Ser. No. 63/521,995, filed Jun. 20, 2023, and the description, drawings and teachings set forth therein are expressly incorporated by reference herein.

### BACKGROUND OF THE INVENTION

Recent reports indicate that the construction industry accounts for somewhere between 30 and 50 percent of greenhouse gas emissions globally. Accordingly, in recent years, there has been an increased focus on tracking and monitoring the carbon emissions associated with construction projects.

Critical path method (“CPM”) scheduling is a holistic tool for managing a project. The CPM scheduling method breaks a larger project into individual activities, which have durations and logical relationships. The critical path of activities is the sequence where, if one activity is delayed, the project's completion will be delayed. In addition to schedule, a CPM schedule can be used to manage a project's costs and resources. Specifically, each activity on the schedule can be “loaded” with the costs and resources associated with that activity. A cost- or resource-loaded schedule can help stakeholders manage a project's cash flow, budget, materials and equipment, staffing, and more.

The present invention described herein enables tracking of Global Warming Potential (GWP) over the life of a construction project by integrating GWP into the CPM schedule. Each activity (or an element of the project's work breakdown structure (“WBS”)) on the schedule is “loaded” with its associated GWP. For certain activities, such as those based on materials, the GWP of that activity will be, essentially, the GWP of the associated materials and the labor associated with installing those materials. For other activities, such as those based on level of effort (“LOE”) (e.g., project management) the GWP of the activity will be the GWP of the staffing required throughout the duration of the activity.

Many project stakeholders-owners, contractors, construction managers, policymakers, and more-would like to have better data about the environmental impact of planned or undertaken projects. This system and method provide that data, as well as associated metrics and analytics, which have been previously unavailable.

This disclosed invention is directed to the challenges of assessing, managing, and optimizing the environmental impact of planned or undertaken construction projects, and to specific improvements in tracking and managing a construction project's GWP that address these challenges. The system and method disclosed as embodiments of the invention improve the acquisition of GWP at each activity (or a WBS element) of a construction project on the CPM schedule accounting for all of the materials and LOE to track and manage GWP throughout the project. Systems and devices that perform the functions at least of: (1) tracking of GWP over the life of a construction project by integrating GWP into the CPM schedule; and (2) “loading” an activity (or a WBS element) on the schedule with its associated GWP, were and are neither routine, well-understood, nor conventional in the field of CPM scheduling.

### SUMMARY OF THE INVENTION

A computer-implemented critical path method (CPM) scheduling system and method integrates carbon emissions associated with construction activities and permits a user to schedule a construction project including those activities. Information is stored regarding one or more milestones, phases, and activities associated with the project. The activity information includes interdependency and carbon emissions information associated with the activity. Based on the milestone information, phase information, and activity information, one or more of the following is calculated: a project schedule; identification, duration, date, and total carbon emission information for key activities; duration, date, and total carbon emission information for phases; and date and total carbon emission information for milestones.

### BRIEF DESCRIPTION OF DRAWINGS

FIGS. 1A-1C depict a fictitious train station project.

FIG. 2 is a table listing details of the materials used in the structures depicted in FIGS. 1A-1C.

FIG. 3A depicts GWP emissions due to materials and fuel.

FIG. 3B depicts GWP emissions due to fuel only.

FIG. 4A depicts Duration changes for LOE activities.

FIG. 4B depicts GWP emissions for LOE activities.

FIG. 5A depicts GWP emissions due to different items.

FIG. 5B depicts Quantity of different types of materials used.

FIG. 5C depicts GWP emissions due to different types of activities using HG Steel.

FIG. 5D depicts GWP emissions due to different types of materials used.

FIG. 6A depicts Volume of different types of concrete used.

FIG. 6B depicts GWP emissions due to different types of concrete used.

FIG. 6C depicts GWP emissions per unit volume of concrete.

FIG. 7A depicts GWP emissions throughout the life cycle of the project for Scenario 1.

FIG. 7B depicts GWP emissions throughout the life cycle of the project for Scenario 2.

FIG. 7C is a Gantt Chart for Construction Phases for Scenario 1.

FIG. 7D is a Gantt Chart for Construction Phases for Scenario 2.

FIGS. 8A-8C depict a fictitious bridge project with scenic overlook and parking.

FIG. 9 is a table listing details of the materials used in the structures depicted in FIG. 8A-8C.

FIGS. 10A-10B are a high-level schedule for the project of FIG. 8A-8C.

FIG. 11 depicts GWP emissions due to materials and fuel for the project of FIGS. 8A-8C.

FIG. 12 depicts GWP emissions due to different items for the project of FIGS. 8A-8C.

FIG. 13A depicts GWP emissions due to steel categories.

FIG. 13B depicts total quantities of steel used.

FIG. 13C depicts GWP emissions in the example scenario.

FIG. 13D depicts total quantities of steel in the example scenario.

FIG. 14A depicts GWP emissions due to different types of concrete used.

FIG. 14B depicts volume of different types of concrete used.

FIG. 15A depicts GWP emissions for LOE activities.

FIG. 15B depicts duration of LOE activities.

FIG. 16 depicts GWP emissions throughout the life cycle of the project.

FIG. 17A depicts the correlation between cost and GWP due to diesel use of equipment.

FIG. 17B depicts the correlation between manhours and GWP due to gas use by personnel.

FIGS. 18A-18B are a table listing a detailed quantity take-off for a few activities.

FIGS. 19A-19B are a table listing total GWP calculated after quantity take-off.

FIG. 20 depicts the evolution of solutions in Genetic Algorithm (GA).

FIG. 21 depicts a Network Diagram of an Example Project.

FIG. 22 depicts the Example Project after FBI Optimization.

FIGS. 23A-23B depict crossover iterations.

### DETAILED DESCRIPTION OF THE INVENTION

Description will now be given of the currently preferred embodiments of the invention. It should be understood that this description is exemplary in nature and in no way serves to limit the scope of the invention, as the invention will be defined by claims, and the scope of the invention will be the scope of the claims, as interpreted by the courts.

The disclosed system and method provide a specific solution for accomplishing the goal of tracking, monitoring, mitigating, and optimizing the carbon emissions associated with a construction project. In the disclosed embodiments, GWP is tracked and monitored at the activity level of a construction project. This is an improvement over prior art systems and methods because it gives decision makers a variety of advantages over existing techniques for multiple reasons:

First, CPM scheduling methodology currently only tracks schedule, cost, and resources associated with a project, not GWP or similar measures related to the environmental impact of a project.

Second, although there are existing tools to track carbon associated with the materials (i.e., not activities) on a project, these tools have multiple limitations: they only track embodied carbon associated with the materials, which is a static measure, and therefore cannot be measured over time; because they are not tracked at the activity level, they cannot be linked to the CPM schedule of a project, so they do not allow a stakeholder to analyze temporal changes in GWP, for example, if work is re-sequenced; they do not take account of LOE emissions (such as the emissions associated with setting up and maintaining a field office) at all; and do not enable the user to calculate various metrics, similar to earned value calculations, based on the data.

The disclosed embodiments are built using software tools in a multi-step sequence. First, a CPM schedule is built that lists all the activities for a project in their appropriate sequence. Second, using quantity take off techniques, the materials associated with each activity are determined. Third, the GWP for each activity-level quantity of materials is determined, using various software tools, relying upon the standard Life Cycle Assessment technique per ISO 14040. At this step, the GWP for LOE activities is determined as well. Finally, using different software tools, each activity on the CPM schedule is “loaded” with the associated GWP. Preferably, the software tools include one or more of those described below; each of these tools is a computer program configured to run on a computer system having a memory and a processor (not shown).

This invention improves existing techniques by integrating activity-level (or a WBS element level) GWP with all of the materials associated with the project, as determined by the quantity takeoff, as well as labor, resources, and LOE activities.

Once the activities on a schedule are GWP-loaded, the user has many tools available to track and monitor the GWP associated with the project. Some examples of the features provided by the disclosed embodiments include:
Analyzing whether alternative materials would reduce GWP and to what extent;
Accounting for emissions due to fuel use (and determining whether alternative equipment or staffing could reduce such emissions);
Using the temporal distribution of GWP to determine whether and how to sequence construction activities;
Calculating sustainability metrics, such as the difference between planned and actual GWP, similar to earned value calculations (e.g., cost variance, schedule variance, etc.);
Managing the GWP associated with level of effort activities, such as site engineering, management, QA/QC testing, etc. (which are not associated with specific materials);
Resolving change orders while taking into account the GWP associated with various options for resolving the change order;
Taking GWP into account whether preparing or analyzing recovery/acceleration schedules in cases of delay.

The following provides further details of embodiments of the invention:

### Cradle to Gate Emissions Modeling for Scheduling of Construction Projects

The project schedule is a tool for the monitoring of a construction project. According to PMBOK Fifth Edition by Project Management Institute, a Critical Path Method (CPM) based schedule model shows activities of the projects interlinked with appropriate relationships. As a result, planned dates, durations, key milestones, and resources can be viewed and analyzed within the schedule model. Project Management Institute (PMI), A Guide to the Project Management Body of Knowledge (PMBOK Guide)—Fifth Edition. Project Management Institute, Inc., PA, USA., 2013. Through Control Schedule, the user is able to monitor the status of activities in the schedule, update forecast dates based on the dynamic changes in the project conditions and compare those changes to the baseline schedule. Project Management Institute (PMI), A Guide to the Project Management Body of Knowledge (PMBOK Guide)—Fifth Edition. Project Management Institute, Inc., PA, USA., 2013. As outlined in the Project Management Plan (PMP) of a project, the project schedule determines when costs will be incurred. Project Management Institute (PMI), A Guide to the Project Management Body of Knowledge (PMBOK Guide)—Fifth Edition. Project Management Institute, Inc., PA, USA., 2013; Project Management Institute (PMI), Practice Standard for Scheduling, 2nd ed., Project Management Institute, Inc., PA, USA., 2011. These costs are either directly loaded into the schedule model or monitored separately through key milestones in the schedule. Therefore, it is evident that a project schedule developed through the CPM technique and monitored throughout the life cycle of a project can provide much-needed information about resources and costs associated with various activities and phases of the project.

Through traditional waterfall-based methods, where the life cycle of a construction project is sequentially planned into various phases of design, construction, testing and commissioning and closeout, or through more dynamic and iterative agile techniques, a project schedule can paint an accurate picture of the status of activities of a project. G. Strasser, “Agile Project Management Concepts Applied to Construction and Other Non-IT Fields,” presented at the PMI Global Congress 2015—North America, Orlando, FL, 2015. This enables agencies or owners, construction managers and contractors to make important decisions about resource allocation and cost control.

In addition to activity durations, resources and cost, there is also a need to monitor the emission of greenhouse gases (GHG) due to construction work that impact climate change. Prior studies have emphasized that concrete and steel are two major contributors of GHG. J. Anthonissen, D. Van Troyen, and J. Braet, “Using carbon dioxide emissions as a criterion to award road construction projects: a pilot case in Flanders,” Journal of Cleaner Production, vol. 102, pp. 96-102, 2015. Some studies have shown ways of monitoring GHG from construction projects, mostly emphasizing the use of sustainable materials. See, e.g., J. Anthonissen, D. Van Troyen, and J. Braet, “Using carbon dioxide emissions as a criterion to award road construction projects: a pilot case in Flanders,” Journal of Cleaner Production, vol. 102, pp. 96-102, 2015; J. Xu, Y. Deng, Y. Shi, and Y. Huang, “A bi-level optimization approach for sustainable development and carbon emissions reduction towards construction materials industry: a case study from China,” Sustainable Cities and Society, vol. 53, p. 101828, 2020; J. M. R. Hernandez, C. Yousif, D. Gatt, E. V. Gomez, J. San Jose, and F. J. R. Martinez, “Modelling the long-term effect of climate change on a zero energy and carbon dioxide building through energy efficiency and renewables,” Energy and Buildings, 2018; P. Xu, Y. J. Huang, N. Miller, N. Schlegel, and P. Shen, “Impacts of climate change on building heating and cooling energy patterns in California,” Energy, vol. 44, no. 1, pp. 792-804, 2012. However, there is a lack of systematic monitoring of the impact of the construction industry towards climate change in the United States. After the United Nations Climate Change Conference (COP26) in 2021, the American Society of Civil Engineers (ASCE) released a communique urging government leaders to work with engineers, owners and other stakeholders of construction projects to create infrastructure to combat and adapt to climate change. ASCE, “ASCE COP26 Communique.” https://www.asce.org/-/media/asce-images-andfiles/communities/institutes-and-technical-groups/sustainability/documents/asce-cop 26-communigue.pdf. More recently, the State of New York will require the tracking of embodied carbon in construction projects. Executive Order No. 22, “Leading by Example: Directing State Agencies to Adopt a Sustainability and Decarbonization Program,” https://www.governor.ny.gov/executive-order/no-22-leading-example-directing-state-agencies-adopt-sustainability—and, Sep. 20, 2022. These are just a few examples underscoring the need to monitor and analyze GHG throughout the life cycle of construction projects. Having a system and method for doing so will enable the stakeholders of a construction project to access vital information related to the environmental emissions responsible for climate change associated with each activity of the project schedule. The environmental emissions along with resources and cost associated with each project will be helpful for the stakeholders of a project to make responsible decisions. This is especially true for government funded projects for which the agencies are answerable to the taxpayers.

The primary goal of this study is to determine environmental emissions in Global Warming Potential (GWP) associated with each activity of the project schedule. Additionally, the study also aims to determine if changes in the sequence of activities result in different total emissions of the project. Finally, this study also aims to analyze temporal changes in GWP emissions throughout the life cycle of the project. As described herein, a methodology of tracking GWP emissions associated with each activity and phase of a construction project is presented. To the best of the authors' knowledge, this is the first time an integrated approach has been developed between project scheduling and GWP emissions at an activity level.

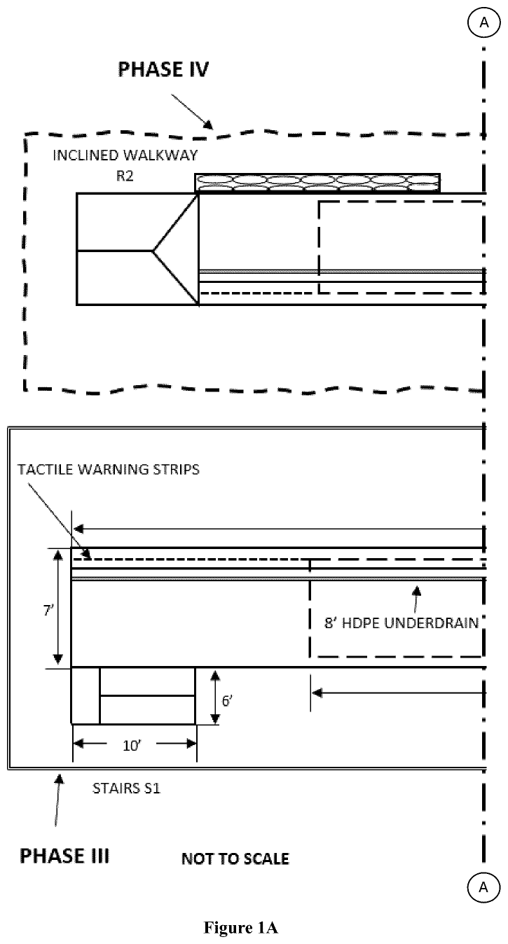

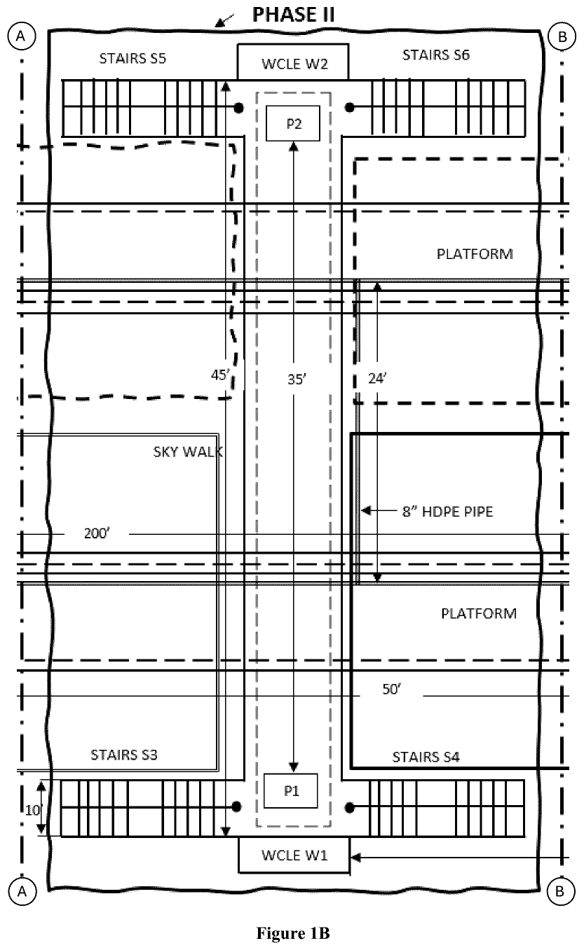

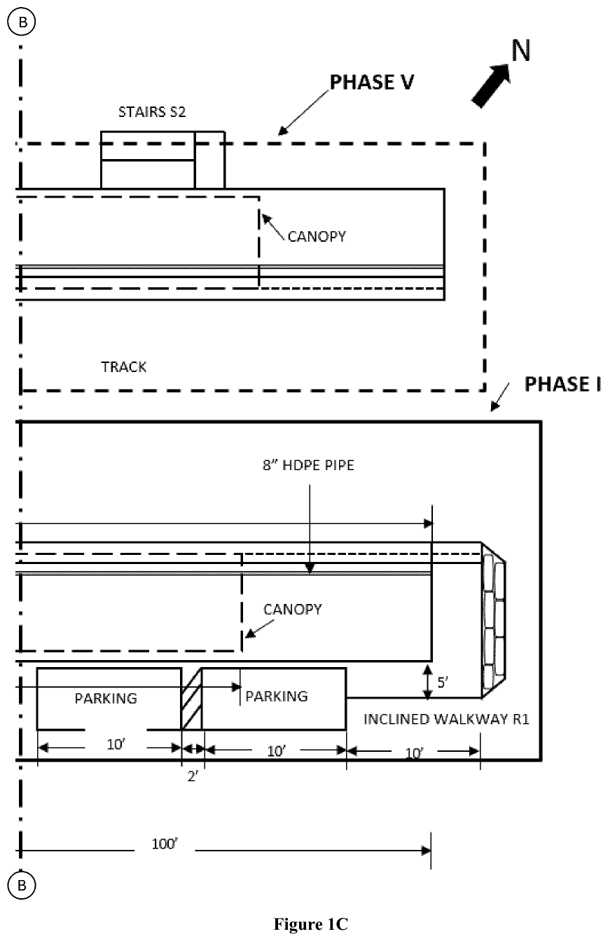

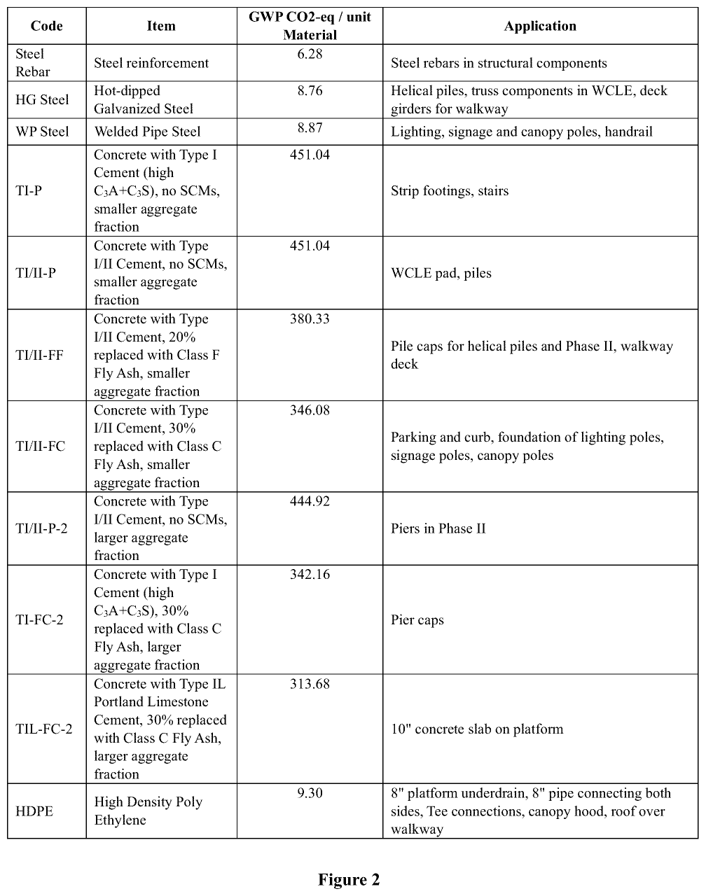

To begin, improvements to a fictitious train station are designed as the study project. The train station is shown in FIGS. 1A-1C (Dimensions are not to scale). The scope of work includes the construction of platforms with overhead canopies on both the sides of the tracks, parking, inclined walkways on both platforms, and a skywalk connecting both the platforms with roof and handrails. Additionally, lights, electrical and communications components will also be installed. The existing station building will be retrofitted with the display and PA systems. Helical piles with depths of 30′ are used as foundations for the platforms and inclined walkways R1 and R2. Three strip footings (6′×2′×2′) each are used as foundations for the stairs S1, S2, S3, S4, S5, and S6. The skywalk is supported by two piers P1 and P2. These piers are supported by two piles each, consisting of 12″ thick steel rings with 24″ outer diameter and a depth of 100′. A rebar cage of 6 #11 vertical bars supported by a spiral with #3 bar with a pitch of 3.5″ is included in each pile, which is filled with concrete. The Skywalk is also equipped with Wheel-Chair Lift Enclosures (WCLE) W1 and W2 on both sides. Details of materials used in these structures can be found in the table in FIG. 2.

Two scenarios of a Critical Path Method (CPM) based schedule model are developed by using the commercial software Oracle Primavera P6. In Scenario 1, after start of construction, Phase I (SE Platform with Parking and Access Ramp will be completed. After Phase I is completed, Phase II (Skywalk and WCLE W1 and W2) and Phase III (SW Platform and Stairs) will be started simultaneously. After completion of Phase III, Phase IV (NW Platform and Stairs) will be executed, followed by Phase V (NE Platform and Stairs). The overall duration of Scenario 1 from Start of Construction to Substantial Completion is 18 months.

In the case of Scenario 2, all the five phases will be completed in series with no overlap between any of them. The overall duration of Scenario 2 from Start of Construction to Substantial Completion is 28 months. In both the scenarios, Level of Effort (LOE) activities are added for site engineering, management and supervision, quality control and testing services, and the use of diesel generator (20 kW) to power the job site to last throughout the project.

The contribution of each activity in the schedule towards climate change is measured by Life Cycle Assessment (LCA). LCA is a tool to quantify the impact of a product or process on the environment. J. T. Harvey, J. Meijer, H. Ozer, I. L. Al-Qadi, A. Saboori, and A. Kendall, “Pavement LifeCycle Assessment Framework,” 2016. In this study, a Cradle to Gate approach is adopted, which is an analysis from the acquisition of raw materials to the end of a process, which may not necessarily mark the end of life of the product. K. Celik, C. Meral, A. P. Gursel, P. K. Mehta, A. Horvath, and P. J. M. Monteiro, “Mechanical properties, durability, and life-cycle assessment of self-consolidating concrete mixtures made with blended portland cements containing fly ash and limestone powder,” Cement and Concrete Composites, vol. 56, pp. 59-72, 2015.

The LCA methodology consists of four stages as outlined in ISO 14040: determination of scope and boundaries, life cycle inventory (LCI), life cycle impact assessment (LCIA) and interpretation of results. International Organization for Standardization, ISO 14040: Environmental Management-Life Cycle Assessment Principles and Framework. Edition 2, 2006. Materials: For concrete, the functional unit is 1 m\hat{ }3. The system boundary consists of production of cement, extraction of raw materials and production of aggregates and admixtures, transportation of materials, mixing at the batching plant, and unit volume of concrete being ready for delivery. Green Concrete LCA webtool is used for the concrete analysis. A. P. Gursel, A. Horvath, GreenConcrete LCA Tool, in, University of California, Berkeley, Berkeley, CA, 2012; see also http://greenconcrete.berkeley.edu. For steel and HDPE, the functional unit is 1 kg. Default Global processes Open LCA commercial software program is used in this study for these materials. C. di Noi, A. Ciroth, M. Srocka. openLCA 1.7 Comprehensive User Manual. GreenDeLTa, Berlin, Germany (2017). Fuel: Environmental emissions leading to climate change due to gasoline use from passenger vehicles used by personnel in the project were calculated based on average fuel consumption, distance commuted, and emission factors defined by Intergovernmental Panel on Climate Change (IPCC), Fourth Assessment. Similarly, the emissions due to diesel from backhoe, crane and concrete truck used in the project are calculated based on hourly diesel consumption and emission factors by IPCC. R. K. Pachauri and A. Reisinger, “IPCC fourth assessment report,” IPCC, Geneva, vol. 2007, 2007.

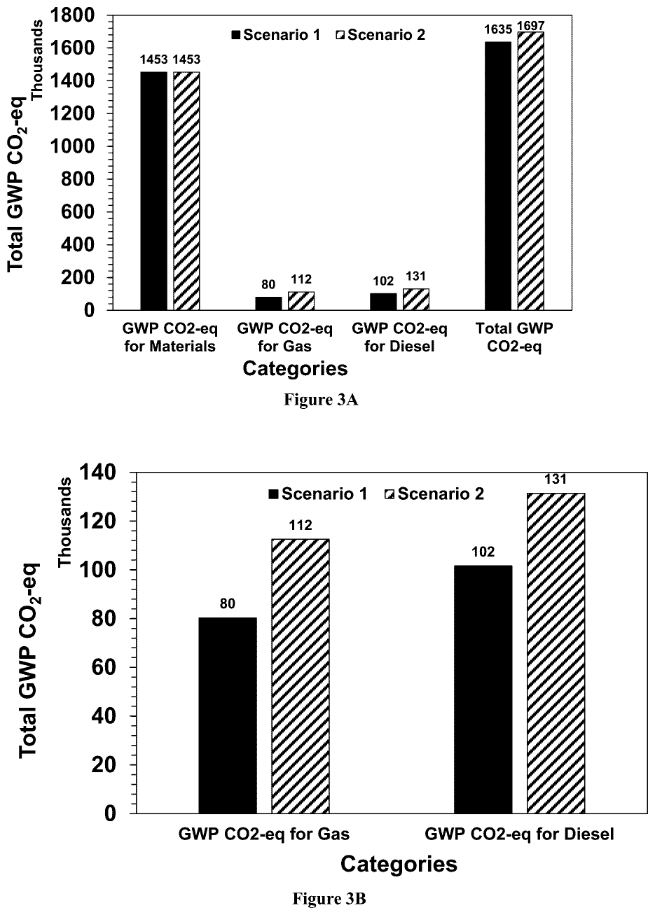

In this study, a Cradle-to-Gate Life Cycle Assessment (LCA) approach is adopted to calculate environmental emissions associated with each activity of the project schedule. In FIGS. 3A-3B, a comparison is made between the emissions affecting climate change in terms of Global Warming Potential (GWP) for Scenarios 1 and 2. Compared to emissions due to fuel, GWP emissions due to the materials used in the project are higher (FIG. 3A). This is also equal in both the scenarios. This is because of the same design, material quantities and types used in case of both the scenarios. FIG. 3B shows that the GWP emissions for gas and diesel are higher in case of Scenario 2 compared to those of Scenario 1. In Scenario 1, the construction activities in Phase II consisting of the walkway bridge occur concurrently with those of Phase III (SW Platform and Stairs), Phase IV (NW Platform and ADA Ramp) and some activities of Phase V (NE Platform and Stairs). However, in the case of Scenario 2, Phase III does not start until Phase II is completed. As a result, the overall project duration is increased from 546 calendar days to 843 calendar days.

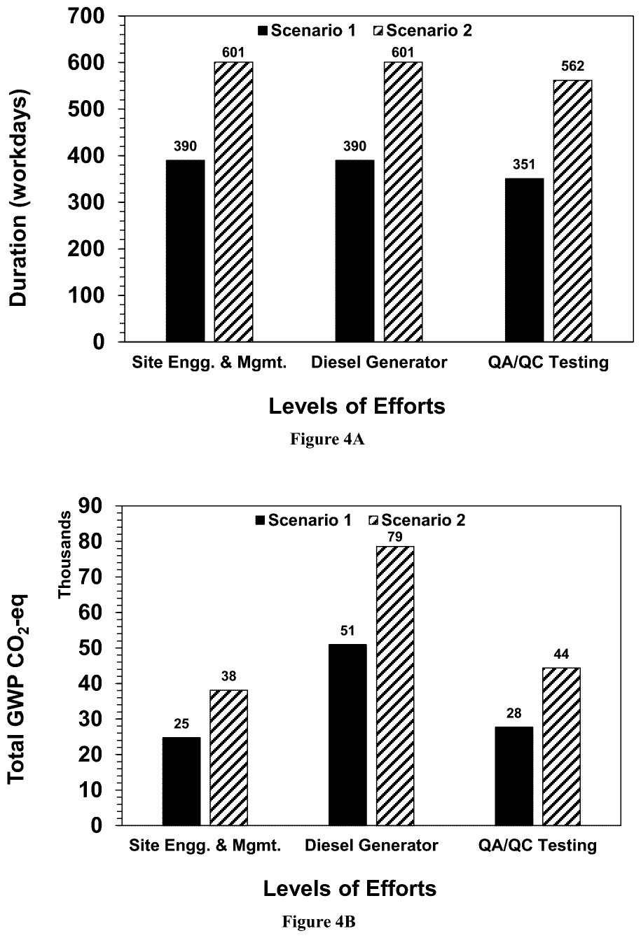

Additionally, the durations of the level of effort activities have also increased in case of Scenario 2 over those of Scenario 1 (FIG. 4A). Because the project duration is longer, these level of effort activities contribute to a greater environmental impact, even though the quantity of materials associated with the project are unchanged. Thus, the role of the project management team for site engineering, management and supervision will not be completed until completion of the project. Additionally, testing and quality control services may be required throughout the completion of all the phases of construction. The personnel associated with these functions are required to commute to work longer in the case of Scenario 2 compared to Scenario 1. As a result, gasoline consumption and resultant GWP emissions are higher in case of Scenario 2 compared to Scenario 1 (FIG. 4B). Moreover, an increase in the overall duration of the project has also increased the hours of operation of generators required to power the job site. As a result, diesel consumption and resultant GWP emissions are higher in case of Scenario 2 compared to Scenario 1 (FIG. 4B).

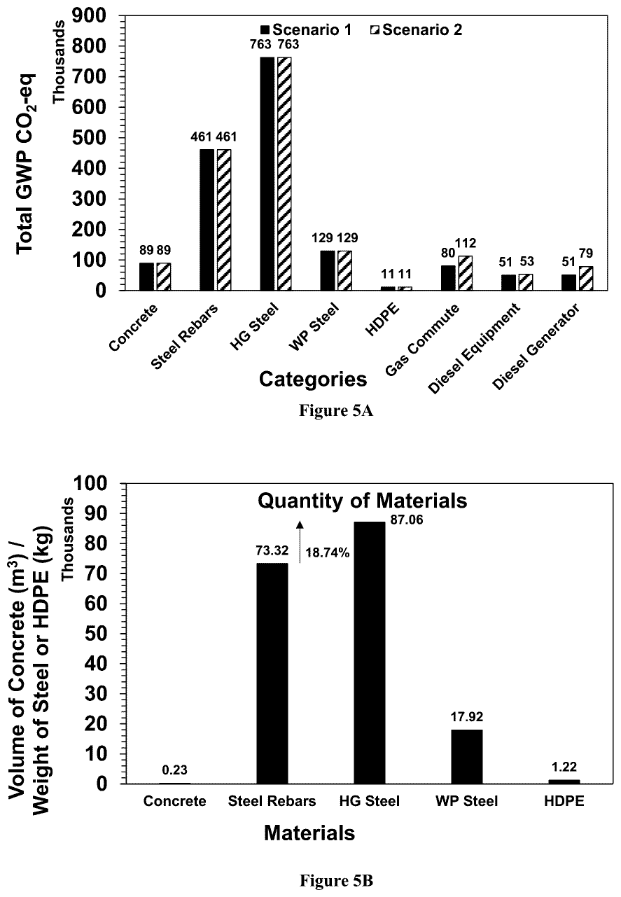

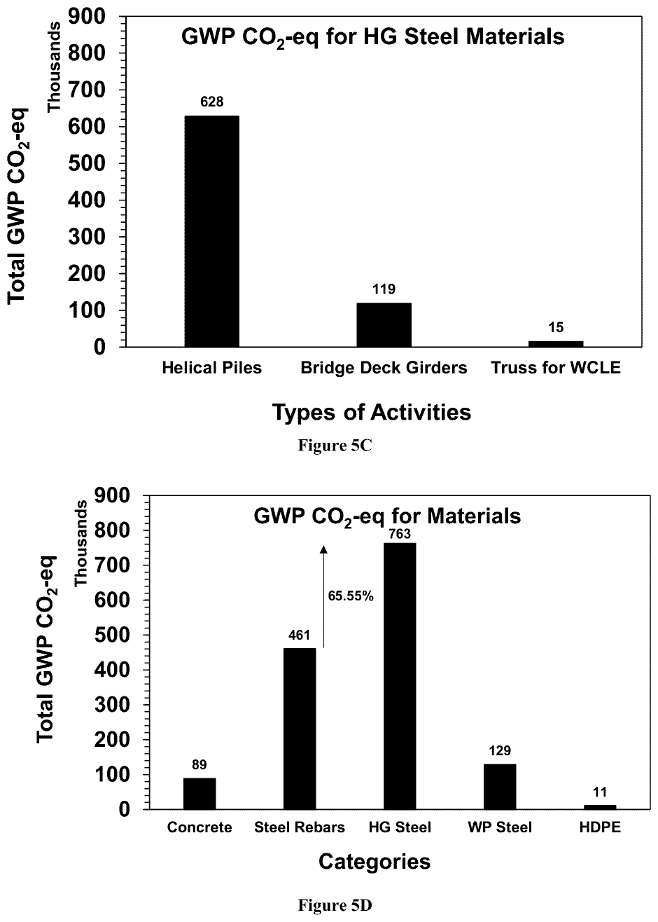

Out of the eight categories of items for which total emissions affecting climate change were calculated in terms of GWP, five (Concrete, Steel Rebars, HG Steel, WP Steel and HDPE) are due to materials used for construction, and three (Gas Commute, Diesel Equipment and Diesel Generator) due to fuel associated with construction. Among the materials used for construction, hot-dipped galvanized steel (HG Steel) has resulted in the highest GWP emissions (FIG. 5A). This is mainly because of a high quantity of HG Steel materials used in this project (FIG. 5B). As evident from FIG. 5C, the bulk of the emissions in this category is due to HG Steel used in the helical piles used as foundations for the platform and helical walkways in Phases I, III, IV and V. Additionally, hot-dipped galvanized steel is also used in the bridge deck girders in Phase II.

In FIG. 5B, it is seen that the quantity of HG Steel is 18.74% higher than that of steel rebars. However, in FIG. 5D, it is seen that the GWP emissions of HG Steel is 65.55% higher than that of steel rebars. This effect is caused by a higher GWP CO2-eq/unit material in the case of hot-dipped galvanized steel (6.28) compared to that of steel reinforcement bars (8.76). Although both HG Steel and rebars are made of steel, the differences in their manufacturing techniques will influence their carbon footprint when used in construction projects. Therefore, this highlights a need to consider alternative materials by designers and government agencies to lower the GWP emissions from construction projects. Notably, because the quantity of materials does not vary with level of effort, the GWP associated with materials alone is the same between Scenario 1 and Scenario 2.

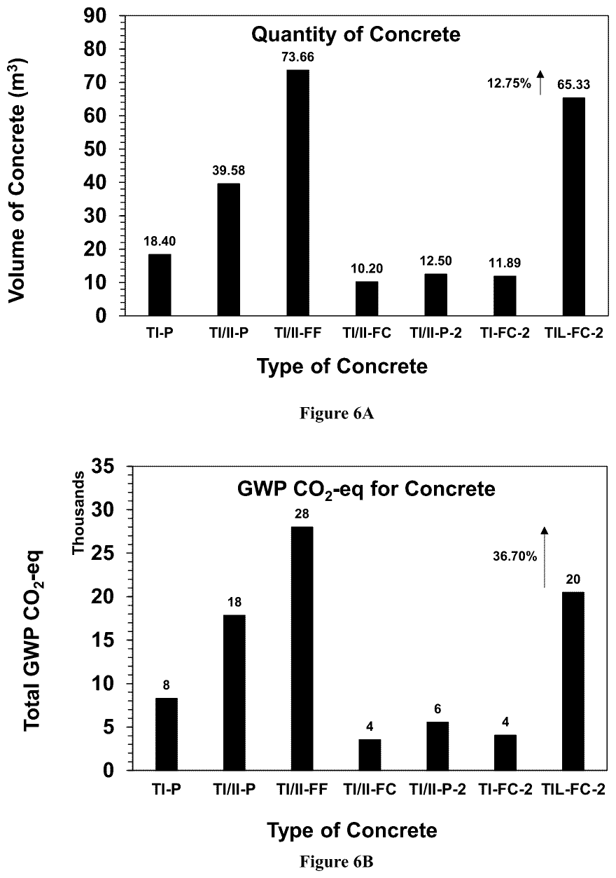

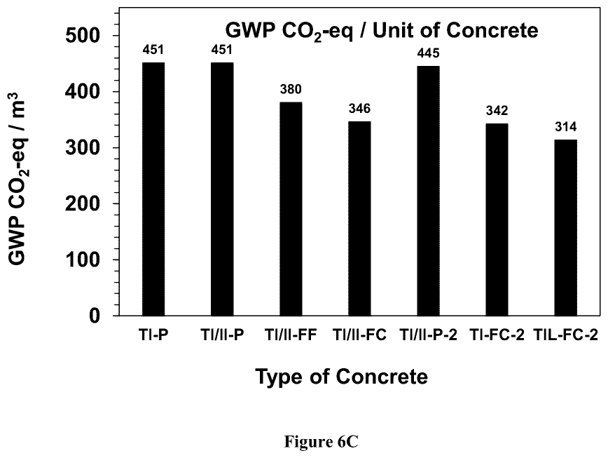

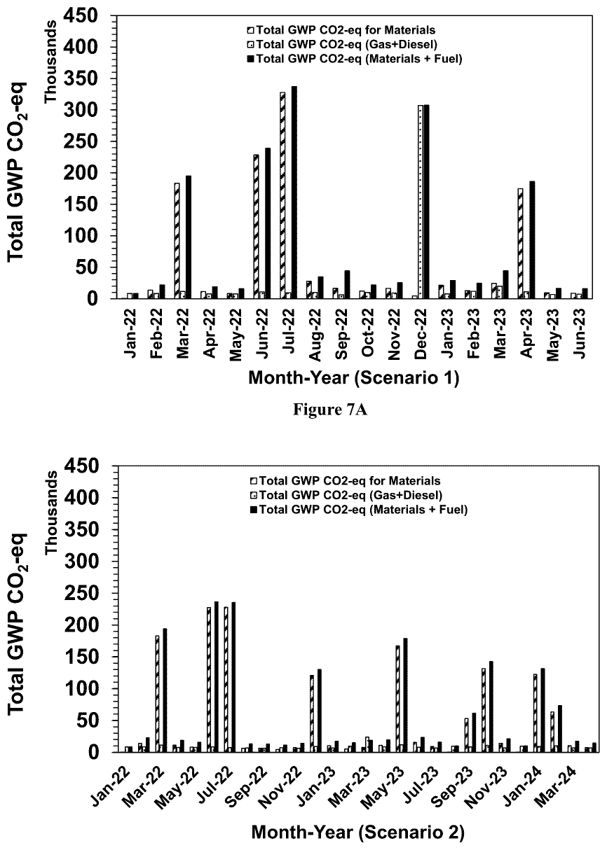

The different types of concrete used in this fictitious project are shown in FIGS. 6A-6C-. FIG. 6A shows the volume of each type of concrete used. Highest quantities are recorded for TI/II-FF and TIL-FF-2. The volume of concrete for TI/II-FF is 12.74% higher than that of TIL-FC-2. However, the resultant GWP emissions due to TI/II-FF concrete mixture is 36.70% higher than that of TIL-FC-2 concrete (FIG. 6B). This is because of a lower GWP CO2-eq/unit volume of TIL-FC-2 compared to TI/II-FF (FIG. 6C). This is mainly because of a 30% replacement of Portland cement with Class C fly ash in the case of TIL-FC-2. A. Sharma, T. Sirotiak, M. L. Stone, X. Wang, and P. Taylor, “Effects of Cement Changes and Aggregate System on Mechanical Properties of Concrete,” Journal of Infrastructure Systems, vol. 27, no. 3, p. 04021012, 2021. Additionally, Type IL Portland Limestone Cement is created by grinding cement clinker with limestone. Overall, this cementitious combination and the resultant concrete are more environmentally sustainable compared to the others used in this project. This once again emphasizes the need to carefully consider the type of materials used for construction.

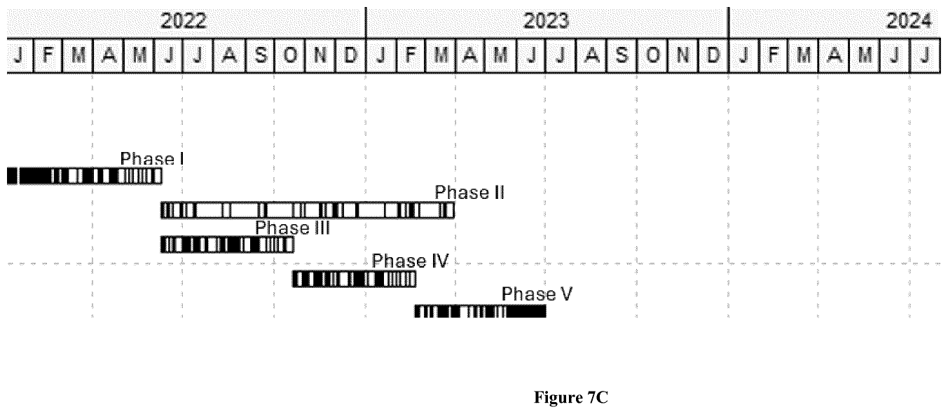

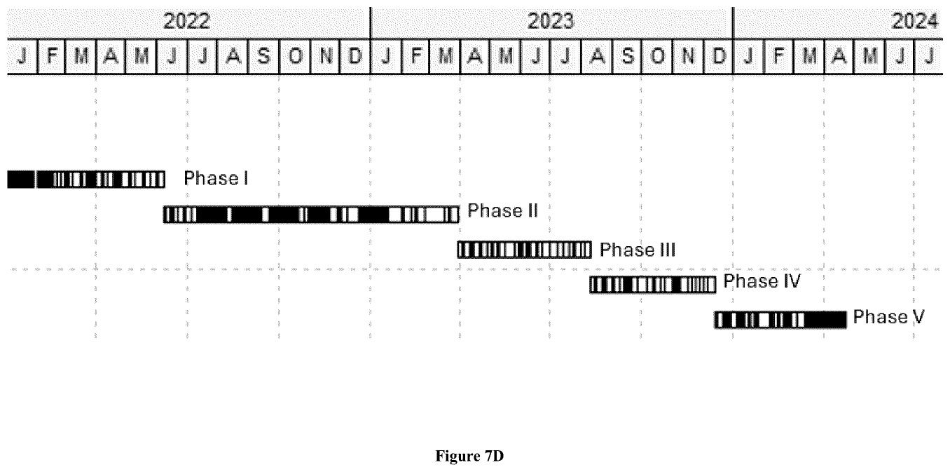

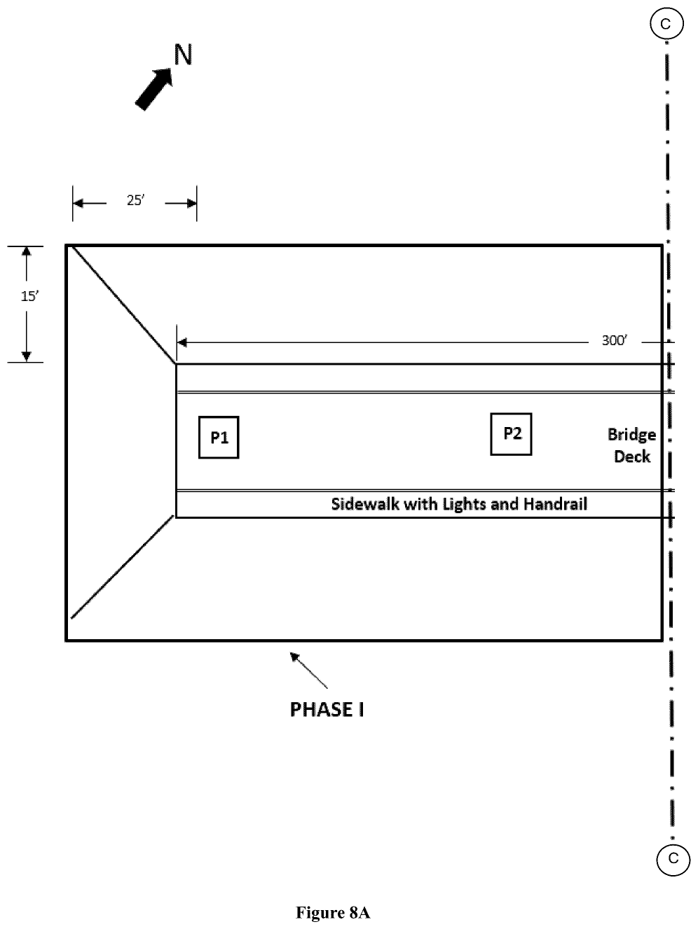

FIGS. 7A and 7B show the monthly GWP emissions from start of construction to substantial completion of the project in Scenarios 1 and 2, respectively. In the case of both the scenarios, the highest emissions appear to be in June and July of 2022. Notably, the emission results in July 2022 in case of Scenario 1 are higher than that of Scenario 2. This is mainly because of an overlap between Phase II and Phase III in Scenario 1 (FIG. 7C). The bulk of these emissions during summer of 2022 are due to materials used in Phases II and III. However, in the case of Scenario 2, Phase III only starts after Phase II is complete (FIG. 7D). Similarly, due to an overlap between the construction activities of walkway deck, handrails and roof in Phase II, and the construction activities in Phase IV, higher GWP emissions are observed in December 2022 in case of Scenario 1 compared to those of Scenario 2. However, this spike in GWP emissions in case of Scenario 1 is mostly from fuel. Prior researchers have determined that there is a relationship between the rate of GWP emissions and the impact on climate change in terms of global warming. J. Lynch, M. Cain, R. Pierrehumbert, and M. Allen, “Demonstrating GWP*: a means of reporting warming-equivalent emissions that captures the contrasting impacts of short- and long-lived climate pollutants,” Environmental Research Letters, vol. 15, no. 4, p. 044023, 2020. There may be some merit in investigating further if bulk environmental emissions within short periods of time pose a higher threat to climate change compared to similar emissions over longer periods of time. Therefore, the rate of environmental emissions due to construction activities should be taken into account.

### Life Cycle Assessment of Activities in Project Schedule: Megaprojects

Megaprojects are complex endeavors which have long-term implications to a region or nation, various industries involved and the society in general. Megaprojects generally cost between 500 million and 1 billion US dollars. C. Biesenthal, S. Clegg, A. Mahalingam, and S. Sankaran, “Applying institutional theories to managing megaprojects,” International Journal of Project Management, vol. 36, no. 1, pp. 43-54, 2018. Many researchers and engineers agree that such complex projects often require a separate set of governing principles and project management strategies due to their huge costs, extended durations, and geo-political implications. In addition to engineering techniques, means and methods, and resource allocation, the success of megaprojects also depends upon local administrative structure, legal systems, and legislations. Such projects are mostly led by federal or state agencies and funded through taxpayer dollars. Therefore, the scope and continuity of such megaprojects often rely upon legislation driven by political will. G. Esposito, T. Nelson, E. Ferlie, and N. Crutzen, “The institutional shaping of global megaprojects: The case of the Lyon-Turin high-speed railway,” International Journal of Project Management, vol. 39, no. 6, pp. 658-671, 2021. Prior researchers have concluded that the management of megaprojects relies upon resources, cost, risks and uncertainties, legal and regulatory issues, socio-economic value, and environmental implications. C. Biesenthal, S. Clegg, A. Mahalingam, and S. Sankaran, “Applying institutional theories to managing megaprojects,” International Journal of Project Management, vol. 36, no. 1, pp. 43-54, 2018.

Some of the ongoing and upcoming megaprojects in the United States include the $17 billion Second Avenue Subway Construction Project in New York, NY, $20 billion Hudson Yards in New York, NY, the $77 billion California High Speed Rail Construction Project in CA, the $1.18 billion Red River Valley Water Supply Project, Washburn, ND, and the $1.5 billion Portal North Bridge replacement project in NJ, etc. M. Thibault. “The 7 biggest megaprojects that have broken ground this year.” https://www.constructiondive.com/news/the-7-biggest-megaprojects-that-have-broken-ground-this-year/607234/; NJ Transit. “Portal North Bridge.” https://www.njtransit.com/portal. These projects and others like them will be subject to legislative priorities set by the government among other things. As outlined by a recent memo released by the American Society of Civil Engineers (ASCE) calling for climate resilient infrastructure, monitoring greenhouse gas (GHG) emissions by construction projects is of utmost importance. ASCE, “ASCE COP26 Communique.” https://www.asce.org/-/media/asce-images-andfiles/communities/institutes-and-technical-groups/sustainability/documents/asce-cop 26-communigue.pdf. Although the environmental implications of megaprojects are considered qualitatively, it is not common industry practice to quantify the environmental emissions due to construction materials and methods. In order to create climate resilient infrastructure, it is important to accurately quantify and monitor environmental emissions associated with megaprojects. The named inventors developed the disclosed embodiments, which represent a new and improved technique of evaluating the environmental impacts of materials, construction methods, equipment, and personnel at an activity level of a Critical Path Method (CPM) based schedule. A. Sharma, P. Deka, G. Jois, U. Jois, and P. Tang, “Cradle to Gate Emissions Modeling for Scheduling of Construction Projects,” in ICCEPM 2022 The 9th International Conference on Construction Engineering and Project Management, Las Vegas, USA, 2022, pp. 975-983. In this study, emissions are expressed as 100-year Global Warming Potential (GWP) CO2-equivalent, as a function of materials, fuel, durations, and cost. Additionally, the temporal changes in GWP emissions are also analyzed for a fictitious bridge project with scenic overlook and parking. This methodology can be scaled up on megaprojects and other projects.

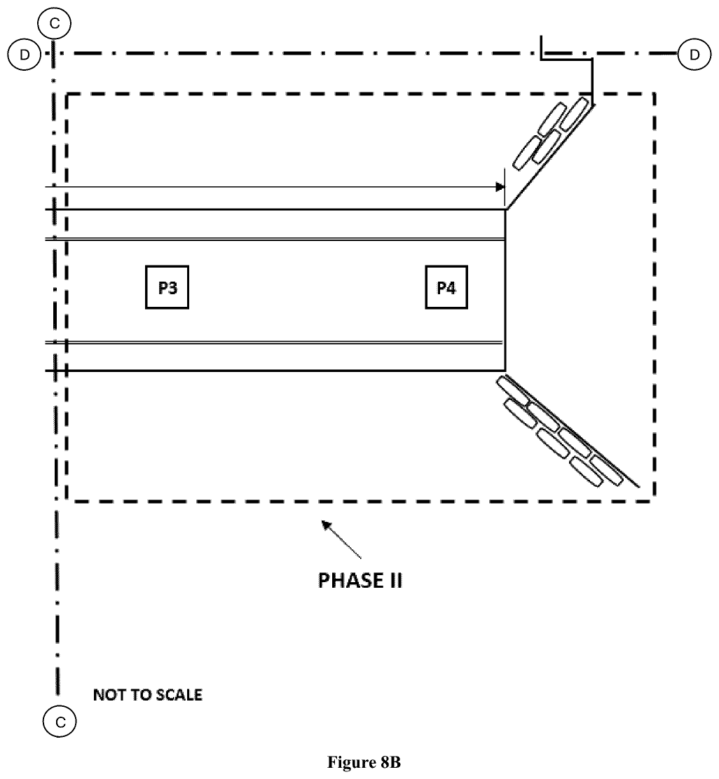

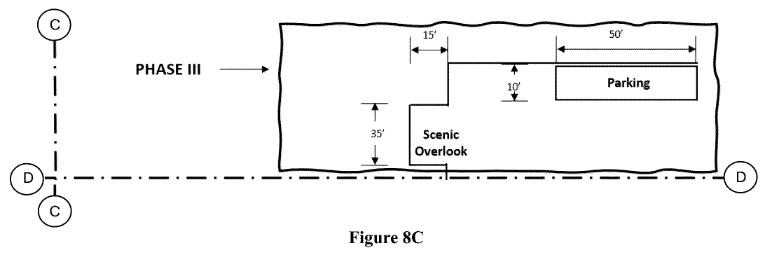

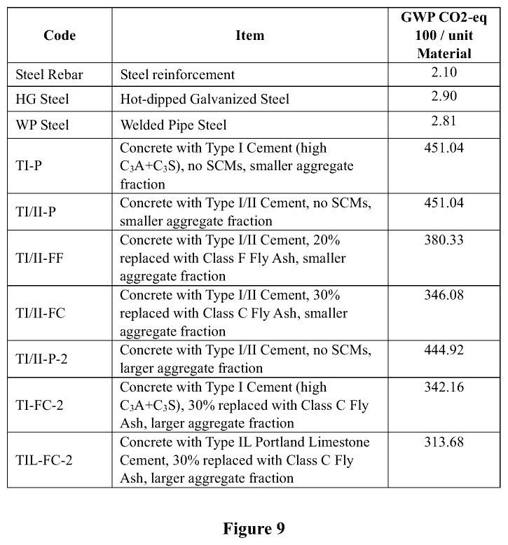

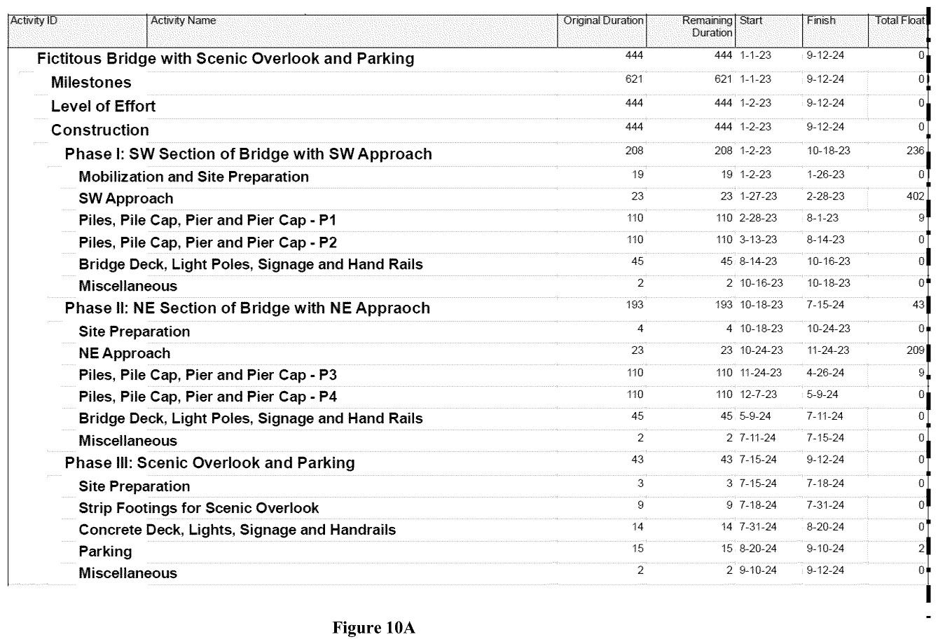

A fictitious bridge project with scenic overlook and parking, is illustrated in FIGS. 8A-8C. The scope of work includes the construction of a bridge consisting of 4 piers with piles and pile caps as foundation and concrete bridge deck with handrails, sidewalk and lights, approach on both the ends (Southwest and Northeast) with helical piles as sub-structures and concrete superstructures, scenic overlook with strip footings and concrete deck, and concrete parking. 47 helical piles with depths of 30′, and 5 strip footings (6′×2′×2′) each are used. Piers P1, P2, P3 and P4 are supported by two piles each, consisting of ½″ thick steel rings with 24″ outer diameter and a depth of 100′. A rebar cage of 6 #11 vertical bars supported by a spiral with #3 bar with a pitch of 3.5″ is included in each pile, which is filled with concrete. Seven different types of concrete are used. Details of materials used in these structures can be found in the table in FIG. 9.

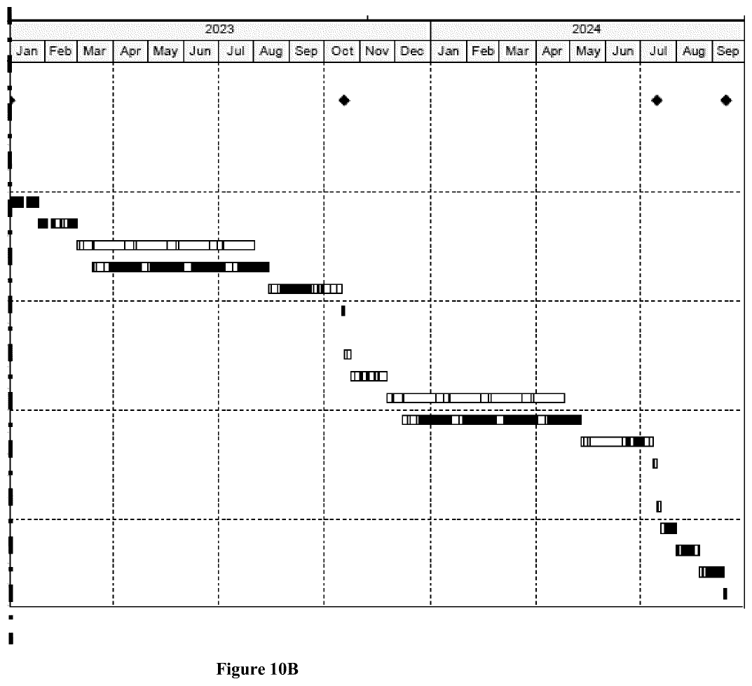

A construction schedule is developed for the fictitious project, illustrated in FIGS. 10A-10B. The work is planned in three phases: Phase I—Southwest section of bridge with approach, Phase II—Northeast section of bridge with approach, and Phase III—Scenic overlook and parking (FIGS. 8A-8C and 10A-10B). Level of Effort (LOE) activities are added for site engineering, management and supervision, quality control and testing services, and the use of diesel generator (20 kW) to power the job site to last throughout the project. The overall duration of the project is NTP+22 months.

The contribution of each activity in the schedule towards climate change is measured by Life Cycle Assessment (LCA). LCA is a tool to quantify the impact of a product or process on the environment. J. T. Harvey, J. Meijer, H. Ozer, I. L. Al-Qadi, A. Saboori, and A. Kendall, “Pavement Life-Cycle Assessment Framework,” 2016. In this study, a Cradle to Gate approach is adopted, which is an analysis from the acquisition of raw materials to the end of a process, which may not necessarily mark the end of life of the product. K. Celik, C. Meral, A. P. Gursel, P. K. Mehta, A. Horvath, and P. J. M. Monteiro, “Mechanical properties, durability, and life-cycle assessment of self-consolidating concrete mixtures made with blended portland cements containing fly ash and limestone powder,” Cement and Concrete Composites, vol. 56, pp. 59-72, 2015. The LCA methodology consists of four stages as outlined in ISO 14040: determination of scope and boundaries, life cycle inventory (LCI), life cycle impact assessment (LCIA) and interpretation of results. International Organization for Standardization, ISO 14040: Environmental Management-Life Cycle Assessment-Principles and Framework, Edition 2, 2006. Impact assessment is performed by the 100-year time horizon approach outlined in IPCC Fifth Assessment Report, 2014 (AR5). IPCC, “IPCC Fifth Assessment Report—Synthesis Report,” ed: IPPC Rome, Italy, 2014.

Materials: For concrete, the functional unit is 1 m\hat{ }3. The system boundary consists of production of cement, extraction of raw materials and production of aggregates and admixtures, transportation of materials, mixing at the batching plant, and unit volume of concrete being ready for delivery. Green Concrete LCA webtool is used for the concrete analysis. A. P. Gursel, A. Horvath, and L. C. A. GreenConcrete Tool, in, University of California, Berkeley, Berkeley, CA, 2012; http://greenconcrete.berkeley.edu. For steel, the functional unit is 1 kg. Open LCA commercial software program is used in this study for these materials. C. Di Noi, A. Ciroth, and M. Srocka, “OpenLCA 1.7,” Comprehensive User Manual, GreenDelta GmbH, Berlin, Germany, 2017.

Fuel: Environmental emissions leading to climate change due to gasoline use from passenger vehicles used by personnel in the project were calculated based on average fuel consumption, distance commuted, and emission factors defined by Intergovernmental Panel on Climate Change (IPCC), Fourth Assessment. Similarly, the emissions due to diesel from backhoe, crane and concrete truck used in the project are calculated based on hourly diesel consumption and emission factors by IPCC. R. K. Pachauri and A. Reisinger, “IPCC fourth assessment report,” IPCC, Geneva, vol. 2007, 2007.

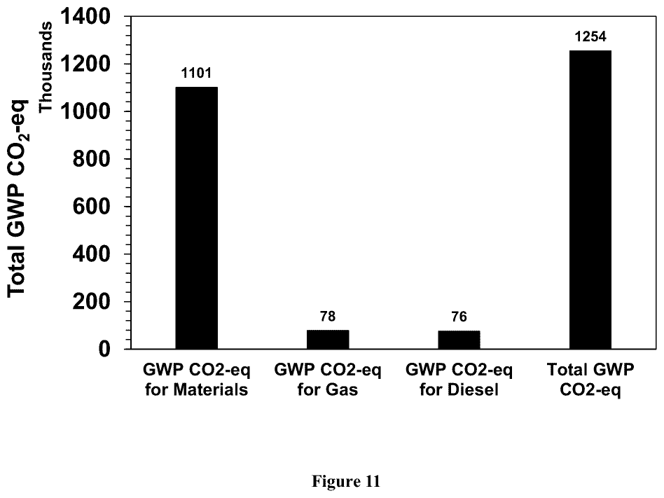

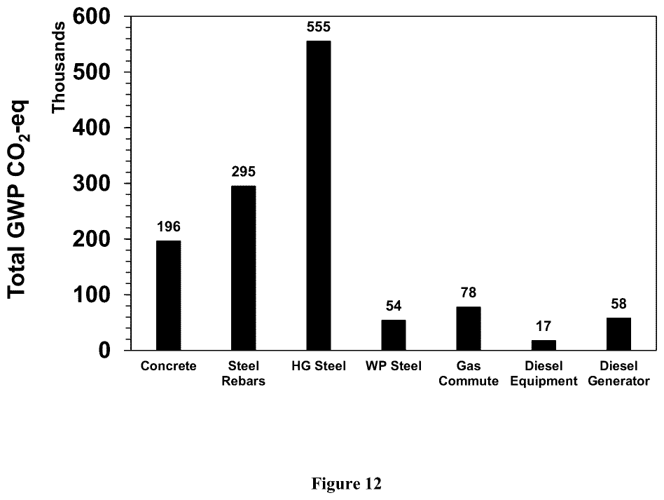

The emissions affecting climate change, expressed as 100-year Global Warming Potential (GWP) CO2-eq analyzed in this study can be broadly classified as those due to materials used for construction, and fuel used. Two types of fuel are used throughout the construction phase-gasoline (gas) and diesel. The use of gas is from passenger vehicles used by personnel to commute to and from the job site. The use of diesel is from equipment used for construction, as well as for generating and maintaining power in the job site. From FIG. 11, it may be observed that the 100 year-GWP emissions due to materials are significantly higher than those due to fuel, i.e., gasoline and diesel. Four major types of materials are used during construction (FIG. 12). These are concrete, steel rebars, hot-dipped galvanized steel (HG Steel), and welded pipe steel (WP Steel). Noticeably, 100-year GWP emissions due to HG Steel are higher than those due to other materials. This is mainly because of a higher quantity used, predominantly in helical piles, and a high rate of 100-year GWP emissions per unit material.

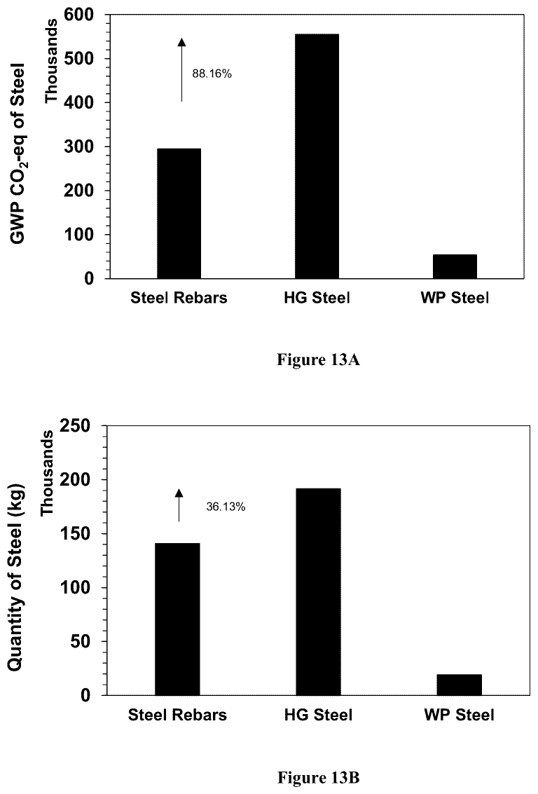

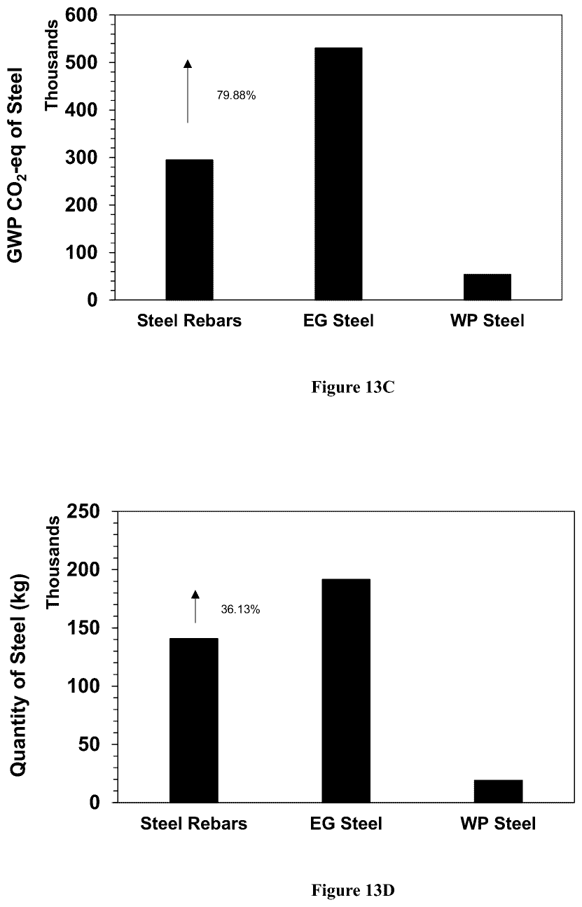

From FIGS. 13A-D, it is evident that the 100-year GWP emissions due to HG steel are 88.16% (FIG. 13A) higher than that of steel rebar, even though the quantity of the former is only 36.13% higher than that of the latter (FIG. 13B). This is notably because of a higher 100-year GWP emissions per unit quantity of HG Steel (2.90 GWP CO2-eq/kg) over steel rebar (2.10 GWP CO2-eq/kg).

This quantification of projected emissions provides owners, construction managers and contractors the opportunity to consider alternative materials in their projects which may be more carbon efficient. In this case, an example scenario is considered where all HG Steel components are replaced with equivalent quantities (in kg) of electrogalvanized steel (EG Steel). The projected 100-year GWP emissions due to EG steel is notably 79.88% higher than that of steel rebar (FIG. 13C), as before, the quantity of the former is only 36.13% higher than that of the latter (FIG. 13D). Overall, EG steel is more carbon efficient than HG steel and would result in 4.6% less 100-year GWP emissions when compared to those due to HG steel.

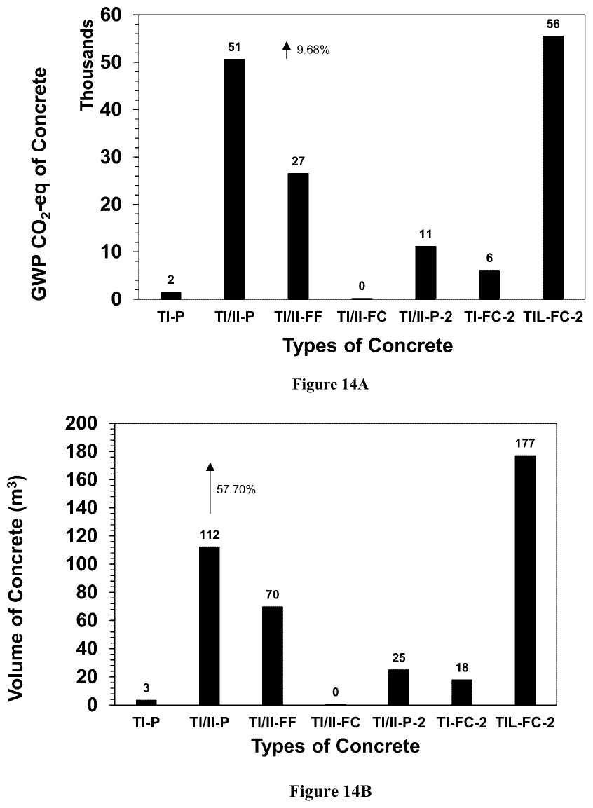

FIG. 14A shows the 100-year GWP emissions due to the seven different types of concrete used in this project. FIG. 14B shows the corresponding volume of concrete used in the various phases of construction. Due to changes in the cementitious composition and aggregate content in the different concrete types used, the rate of emissions is varied. As an example, the volume of TIL-FC-2 is over 57% higher than that of TI/II-P. However, the estimated 100-year GWP emission of TIL-FC-2 is only about 10% higher than that of TI/II-P. This is due to a lower unit GWP emission of TIL-FC-2 due to the use of Type IL Portland limestone cement and partial replacement with Class C fly ash. A. Sharma, T. Sirotiak, M. L. Stone, X. Wang, and P. Taylor, “Effects of Cement Changes and Aggregate System on Mechanical Properties of Concrete,” Journal of Infrastructure Systems, vol. 27, no. 3, p. 04021012, 2021.

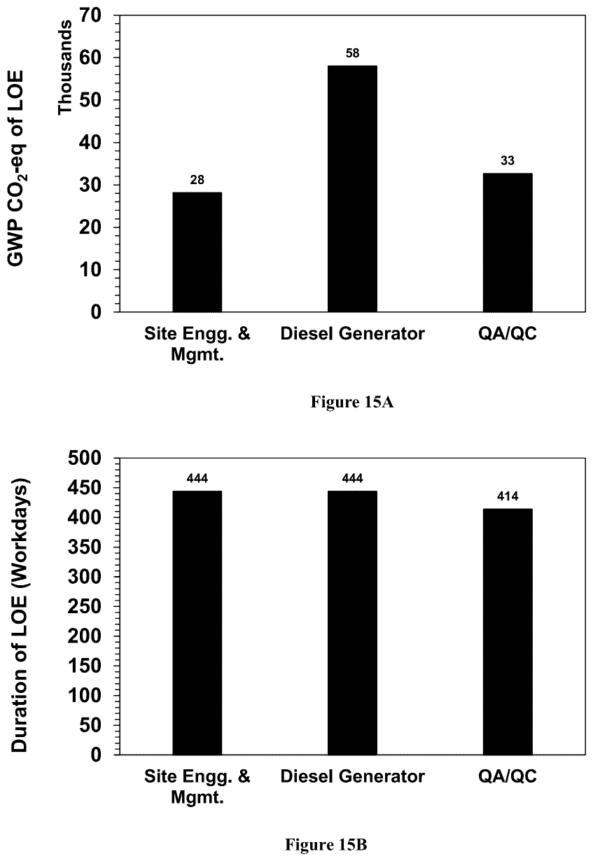

FIGS. 15A-B shows three categories which are represented as Level of Effort (LOE) activities in the construction schedule of this project. The 100-year GWP emissions due to diesel used in powering the job site is projected to be the highest among the LOE categories (FIG. 15A). It is assumed that the generator will be used for 8 hours every workday throughout the duration of the project. Compared to the commute of engineers and project managers, and quality engineering personnel for similar duration throughout the project (FIG. 15B), the emissions from the generator are projected to be considerably higher (FIG. 15A). Overall, these LOE activities and the resultant emissions are directly driven by the total duration of the project, and they are not directly tied to the quantity of materials used. (In other words, the same quantity of materials installed over a longer period of time would result in higher LOE emissions even though emissions due to materials would be identical.) Therefore, this tool provides the project managers and project controls personnel with an assessment of emissions due to potential delays in the project duration.

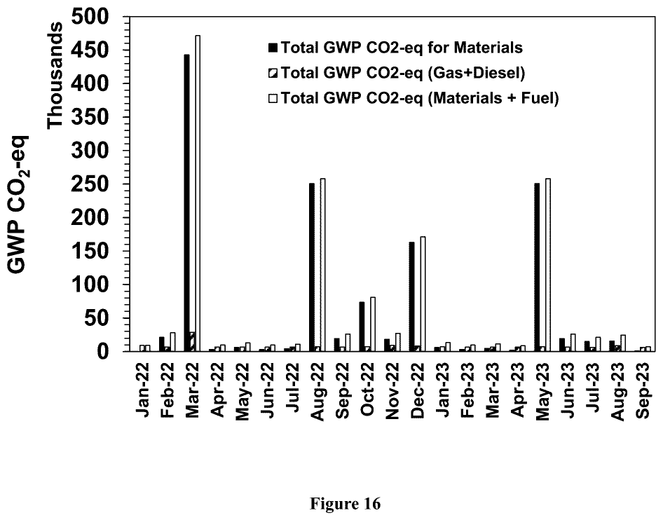

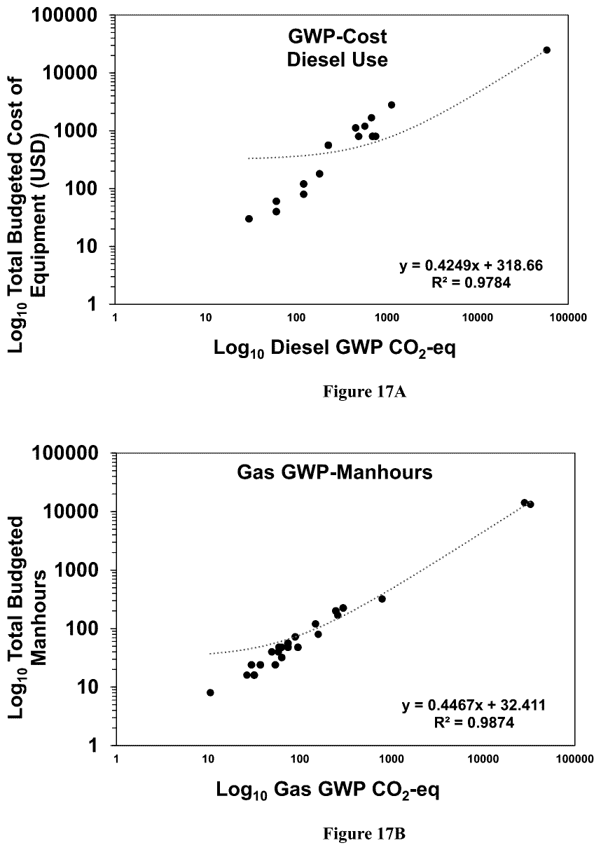

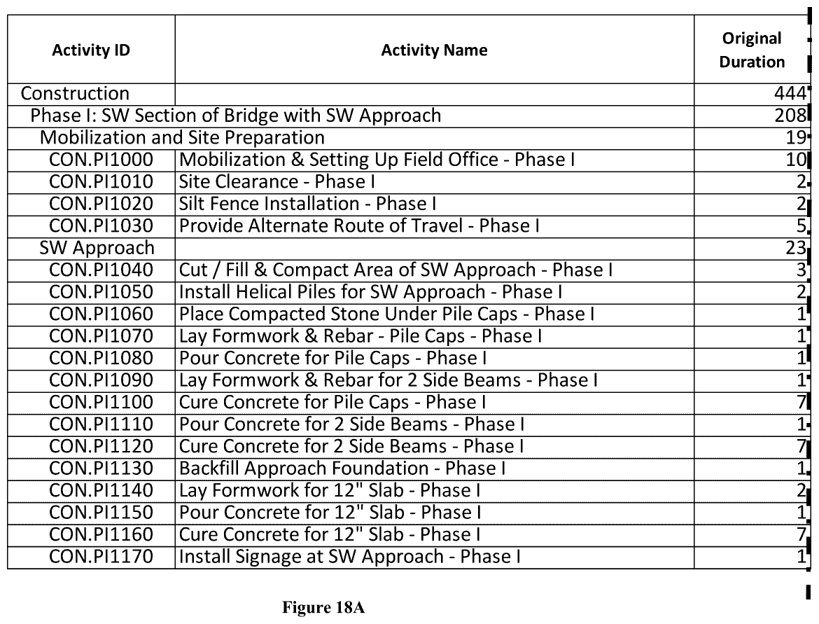

FIG. 16 shows the distribution of 100-year GWP emissions over the 22 months of the project. One of the major advantages of this new methodology is the ability of a construction manager or contractor to analyze the estimated emissions dynamically over the course of the project schedule. The temporal chart shows peaks of GWP emissions on some months over others. The highest peak emissions can be seen in March 2022 or 3 months after start of construction. The detailed schedule shows that during this period, pile, pile caps, pier, and pier caps of P1 and P2 will be installed during Phase I of construction. Significant amounts of concrete and steel will be used in this period, which explains the peak in GWP emissions. Prior studies have investigated relationships between the rate of GWP emissions and the impact on climate change. J. Lynch, M. Cain, R. Pierrehumbert, and M. Allen, “Demonstrating GWP*: a means of reporting warming-equivalent emissions that captures the contrasting impacts of short- and long-lived climate pollutants,” Environmental Research Letters, vol. 15, no. 4, p. 044023, 2020. This rate of emissions could be an important consideration as huge peaks of GWP emissions within short periods of time may be more detrimental to climate change compared to a steadier release of such emissions. Currently, project stakeholders do not have a tool to analyze the temporal distribution of GWP, including analyzing GWP dynamically as activities are re-sequenced, “What if?” scenarios are considered, and the like.

FIGS. 17A-B shows log-log correlations between 100-year GWP emissions, and cost and manhours. FIG. 17A shows that the total budgeted cost of equipment is directly proportional to the 100-year GWP emitted by the use of diesel, on a log-log plot. Similarly, FIG. 17B shows that the total budgeted person-hours in the project is directly proportional to the 100-year GWP emitted by the use of gasoline during commute, on a log-log plot. Such correlations between emissions and cost and manhours could be seen because the use of gas or diesel is considered in terms of miles commuted or hours of operation. Similarly, GWP emissions due to gas and diesel are also calculated based on the average consumption per mile or per hour. However, such correlations were not obvious in the case of materials used in the project. This is due to the more complex nature of estimating emissions due to different materials and their varied quantities.

The embodiments disclosed above represent a new and improved technique of evaluating the environmental impacts of materials, construction methods, equipment and personnel is presented at an activity level of a Critical Path Method (CPM) based schedule of a fictitious bridge project with a scenic overview and parking. This technique can be scaled up for megaprojects. The following are the key conclusions:
The 100 year-GWP emissions due to materials are significantly higher than those due to fuel.
GWP emissions due to HG Steel are higher than the other steel types due to a higher unit emission; EG Steel can be alternately used to reduce emissions.
GWP emissions plotted per time showed peaks in specific periods, thereby throwing light on differing rates of emissions.
   Integrating Sustainability Metrics with CPM Schedules: A New Approach with Applications in the Construction Industry

The impacts of global warming and climate change have been profoundly felt across the world in recent years due to which, environmental sustainability could be considered as one of the most important needs of the planet of our times. Governments and agencies around the world have made organized efforts to address the problem of climate change by a combination of (a) mitigating carbon emissions by reducing the embodied carbon associated with materials by using more environmentally sustainable manufacturing techniques, and (b) developing climate resilient infrastructure. In the United States, important pieces of legislation like the Infrastructure Investment and Jobs Act have provisions for developing climate resilient infrastructure throughout the country. The goal is to develop buildings, bridges, roads, dams, etc., which can withstand extreme weather events, which were previously estimated to occur once in a hundred years etc. Taking a note from the United Nations Climate Change Conference (COP26) in 2021, the American Society of Civil Engineers (ASCE) released a communique outlining the importance of infrastructure adaptive to extreme weather events from climate change. ASCE, “ASCE COP26 Communique.” https://www.asce.org/-/media/asce-images-and-files/communities/institutes-and-technical-groups/sustainability/documents/asce-cop26-communique.pdf. Therefore, it is evident that the construction industry is focused on developing climate resilient infrastructure.

The processes of project management and control are intended to monitor the health and smooth functioning of construction and other projects. A project schedule is a holistic tool to plan, execute and monitor a project. As described in Project Management Institute (PMI)'s PMBOK (Fifth Edition), a schedule model based on critical path method (CPM) relies on logic and relationships between activities with estimated durations to represent scope to be performed under the project. A CPM schedule provides the user with planned dates of key milestones and activities as well as resources to be used. Project Management Institute (PMI), A Guide to the Project Management Body of Knowledge (PMBOK Guide)—Fifth Edition. Project Management Institute, Inc., PA, USA., 2013. Once a project baseline is established, project performance can be assessed for actual versus planned dates and cost. Furthermore, earned value management can provide schedule and cost variances which are indicators of the health of the project. According to Total Cost Management Framework by AACEi, actual project performance can be compared against planned performance, and corrective or change actions can be implemented appropriately during project controls. J. Hollmann and W. R. Querns, “The Total Cost Management (TCM) Framework,” Cost Engineering, vol. 43, no. 3, p. 14, 2001. Therefore, it is evident that under the purview of project management and control, a project schedule is an effective tool for smart management of the project.

Research Gap 1: With the intent of establishing the primary research gap, it is important to note that while the project schedule can provide the user with planned and actual information regarding dates, durations, resources and cost, the current state of the art of CPM scheduling fails to provide the user with any information related to sustainability metrics/environmental impact of the project. The authors acknowledge that other efforts have been made to monitor emissions of greenhouse gases (GHG) associated with materials known as embodied carbon. J. Xu, Y. Deng, Y. Shi, and Y. Huang, “A bi-level optimization approach for sustainable development and carbon emissions reduction towards construction materials industry: a case study from China,” Sustainable Cities and Society, vol. 53, p. 101828, 2020; J. M. R. Hernández, C. Yousif, D. Gatt, E. V. Gomez, J. San Jose, and F. J. R. Martinez, “Modelling the long-term effect of climate change on a zero energy and carbon dioxide building through energy efficiency and renewables,” Energy and Buildings, 2018. To the best of the inventors' understanding, however, currently the construction industry does not have a systematic and standardized way of estimating and monitoring greenhouse gas emissions in projects at the activity level.

Research Gap 2: In recent years, other parties have made certain efforts to calculate embodied carbon of materials used in construction projects as a function of estimating (ARES PRISM, Rapid DCS etc.). However, the embodied carbon may not necessarily consider carbon emissions associated with transport and use of those materials. Moreover, the emissions resulting from equipment and manpower during construction is also not considered in the estimating approach. Therefore, even the limited efforts to analyze emissions associated with a construction project have shortcomings.

Solution: The named inventors developed the disclosed embodiments, which represent a new and improved approach of integrating a project's CPM schedule with the carbon footprint of the project. In this method, the greenhouse gas emissions impacting climate change, expressed as 100-year global warming potential (GWP) CO2-equivalent, are estimated at an activity level of a CPM schedule. For the quantification of GWP emissions, the embodied carbon of materials, and those from fuel use by equipment and personnel etc. are considered. A. Sharma, P. Deka, G. Jois, U. Jois, and P. Tang, “Cradle to Gate Emissions Modeling for Scheduling of Construction Projects,” in ICCEPM 2022 The 9th International Conference on Construction Engineering and Project Management, Las Vegas, USA, 2022, pp. 975-983. By integrating GWP quantification with CPM schedule, this approach establishes a systematic methodology for the holistic monitoring of sustainability of a project under the purview of project controls, thereby addressing Research Gap 1. Furthermore, due to the quantification of emissions at an activity level, this method has the capability of assessing planned versus actual emissions as a function of time. This can be similar to earned value analysis for schedule and cost. Moreover, in addition to embodied carbon associated with construction materials, this unique approach also considers GWP for fuel used in equipment and commute of personnel, powering of jobsite etc. Therefore, this addresses Research Gap 2.

The method consists of the following steps:

### (1) Schedule Development and Quantity Takeoff

The scope, design, drawings, and materials used in the concerned project need to be thoroughly reviewed as the first step of the process. After the design and construction schedule is developed (preliminary or baseline), it is important to calculate the quantities associated with each activity through quantity take-off. In order to illustrate the methodology, an example is presented below, which was published elsewhere. A. Sharma, P. Deka, G. Jois, and U. Jois, “Life Cycle Assessment (LCA) of Activities in Project Schedule: Megaprojects,” presented at the Project Controls Expo, Washington D.C., USA, 2021, https://projectcontrolexpo.com/assets/user_assets/usa/Faq/PCE_JCMS_Megaprojects.pdf. The following discussion is taken from that article.

Schedule Development: In this example, a fictitious bridge project with scenic overlook and parking, is considered (FIGS. 8A-8C). The scope of work includes the construction of a bridge consisting of 4 piers with piles and pile caps as a foundation and concrete bridge deck with handrails, sidewalk and lights, approach on both the ends (Southwest and Northeast) with helical piles as a substructure and concrete superstructures, scenic overlook with strip footings and concrete deck, and concrete parking. 47 helical piles with depths of 30′, and 5 strip footings (6′×2′×2′) each are used. Piers P1, P2, P3 and P4 are supported by two piles each, consisting of ½″ thick steel rings with 24″ outer diameter and a depth of 100′. A rebar cage of 6 #11 vertical bars supported by a spiral with #3 bar with a pitch of 3.5″ is included in each pile, which is filled with concrete. Seven different types of concrete are used. Details of materials used in these structures can be found in the table in FIG. 9.

A construction schedule is developed for the fictitious project. The work is planned in three phases: Phase I—Southwest section of bridge with approach, Phase II—Northeast section of bridge with approach, and Phase III—Scenic overlook and parking (FIG. 2). Level of Effort (LOE) activities are added for site engineering, management and supervision, quality control and testing services, and the use of diesel generator (20 kW) to power the job site to last throughout the project. The overall duration of the project is NTP+21 months.

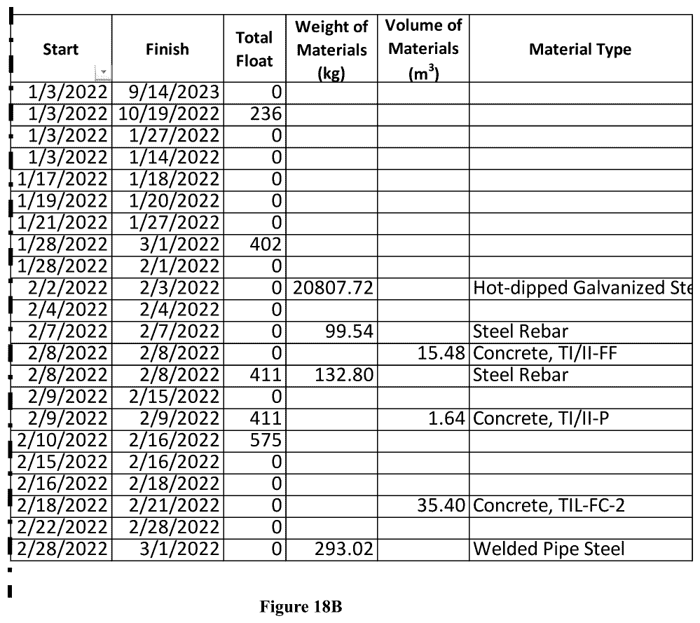

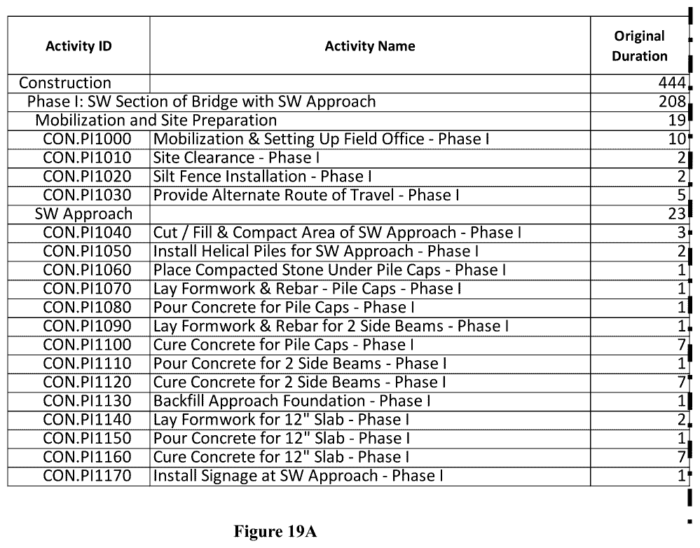

Quantity Take-Off: As soon as the schedule is developed, the next step is to perform a detailed quantity take-off at an activity level. For each activity, the materials to be used are identified carefully from approved drawings, and the weights and volumes are calculated. This is illustrated in the table in FIGS. 18A-18B. It should be noted that in addition to materials and their quantities, the resources (personnel and equipment) used in each activity will also have an impact on their carbon emissions. Although assigning resources to the activities may be the preferred method of project controls, it is not entirely necessary for the purposes of tracking emissions. The resources for each activity can be tracked in a spreadsheet. As an example, if a backhoe is used to cut/fill and compact area of the SW approach (Activity ID: CON.PI1040), the hours of operations for the duration of the activity can provide information on the amount of diesel fuel used based on average fuel consumption of the backhoe. The GWP emissions per unit volume of diesel can then be multiplied by the volume of diesel used to calculate total emissions. Similarly, the personnel used in an activity will have to commute to and from work. If passenger vehicles are used, then the amount of gasoline consumed during the days of the activity and resultant GWP emissions can be calculated. Some larger projects may provide shuttle buses or similar transportation for work crews, which in turn can mitigate the GWP from emissions.

### (2) Life Cycle Assessment

The contribution of each activity in the schedule towards climate change is measured by Life Cycle Assessment (LCA). LCA is a tool to quantify the impact of a product or process on the environment. J. T. Harvey, J. Meijer, H. Ozer, I. L. Al-Qadi, A. Saboori, and A. Kendall, “Pavement Life-Cycle Assessment Framework,” 2016. In this study, a Cradle to Gate approach is adopted, which is an analysis from the acquisition of raw materials to the end of a process, which may not necessarily mark the end of life of the product. K. Celik, C. Meral, A. P. Gursel, P. K. Mehta, A. Horvath, and P. J. M. Monteiro, “Mechanical properties, durability, and life-cycle assessment of self-consolidating concrete mixtures made with blended portland cements containing fly ash and limestone powder,” Cement and Concrete Composites, vol. 56, pp. 59-72, 2015. The LCA methodology consists of four stages as outlined in ISO 14040: determination of scope and boundaries, life cycle inventory (LCI), life cycle impact assessment (LCIA) and interpretation of results. International Organization for Standardization, ISO 14040: Environmental Management- Life Cycle Assessment-Principles and Framework, Edition 2, 2006. Impact assessment is performed by the 100-year time horizon approach outlined in IPCC Fifth Assessment Report, 2014 (AR5). R. K. Pachauri et al., Climate change 2014: synthesis report. Contribution of Working Groups I, II and Ill to the fifth assessment report of the Intergovernmental Panel on Climate Change. IPCC, 2014. Materials: For concrete, the functional unit is 1 m3. The system boundary consists of production of cement, extraction of raw materials and production of aggregates and admixtures, transportation of materials, mixing at the batching plant, and unit volume of concrete being ready for delivery. Green Concrete LCA webtool is used for analysis of concrete. A. P. Gursel, A. Horvath, and L. C. A. GreenConcrete Tool, in, University of California, Berkeley, Berkeley, CA, 2012; http://greenconcrete.berkeley.edu. For steel, the functional unit is 1 kg. Open LCA commercial software program is used in this study for these materials. C. Di Noi, A. Ciroth, and M. Srocka, “OpenLCA 1.7,” Comprehensive User Manual, GreenDelta GmbH, Berlin, Germany, 2017.

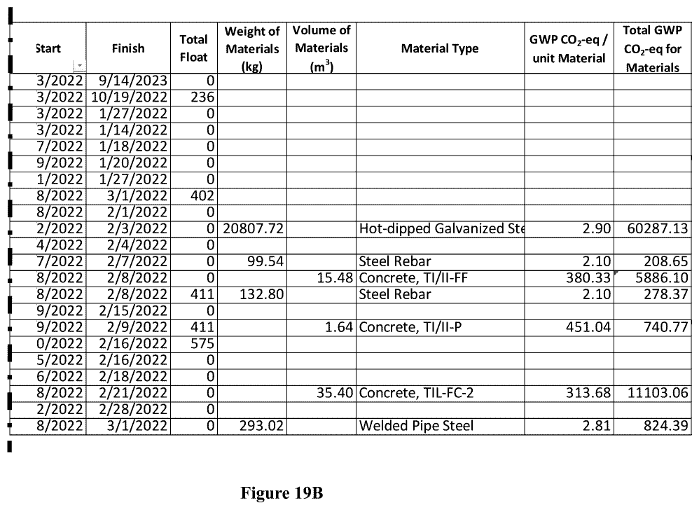

Fuel: Environmental emissions leading to climate change due to gasoline use from passenger vehicles used by personnel in the project were calculated based on average fuel consumption, distance commuted, and emission factors defined by Intergovernmental Panel on Climate Change (IPCC), Fourth Assessment. Similarly, the emissions due to diesel from backhoe, crane and concrete truck used in the project are calculated based on hourly diesel consumption and emission factors by IPCC. IPCC, “IPCC Fifth Assessment Report—Synthesis Report,” ed: IPPC Rome, Italy, 2014. If one activity involves multiple equipment and resources, then each type of equipment will have to be evaluated individually. Total emissions from different equipment for each activity will be calculated. The unit emissions calculated for the materials through the LCA process are shown in the table in FIGS. 19A-19B.

Similarly, the 100-year GWP emissions for gas consumption (from commute of personnel), and diesel consumption (from equipment, generators etc.) can be calculated from standard reports. IPCC, “IPCC Fifth Assessment Report—Synthesis Report,” ed: IPPC Rome, Italy, 2014. After the unit emissions are calculated through the LCA process, the embodied carbon associated with the materials can be calculated for each activity as a function of the calculated weights and volumes of the materials. This process is shown in the table in FIGS. 19A-19B.

The methodology described calculates the total GWP emissions contributed by materials and fuel at an activity level of the schedule, as applicable. This can be termed as static analysis, which is only slightly more advanced than emission calculations as a function of cost estimating. The methodology developed by the named inventors is also capable of performing dynamic analysis, which is explained below:

Through this process, the total 100-year GWP emissions can be calculated for the different materials used during the project (embodied carbon). Moreover, total emissions from fuel can also be calculated. This information will help the owners, construction managers and project controls personnel to monitor the emissions due to materials and fuel for the project. It is generally understood that sustainable materials and construction practices are recommended. However, these efforts will be more effective if systematic approaches of carbon monitoring and sustainability in construction projects are mandated by contract specifications and general requirements etc. Targets can be set and monitored through sustainability metrics as discussed in the subsequent sections below. This method also provides the user with the opportunity of exploring alternative materials which may be more carbon efficient. This is illustrated in FIGS. 13A-D and 14A-B. See also A. Sharma, P. Deka, G. Jois, and U. Jois, “Life Cycle Assessment (LCA) of Activities in Project Schedule: Megaprojects,” presented at the Project Controls Expo, Washington D.C., USA, 2021, https://projectcontrolexpo.com/assets/user_assets/usa/Faq/PCE_JCMS_Megaprojects.pdf.

To illustrate this point, a different type of steel called electro-galvanized steel (EG Steel) can be assumed to replace all hot-dipped galvanized steel (HG Steel) in this project. As EG Steel is more environmentally friendly and carbon efficient, GWP emissions are reduced by 4.6% (see FIGS. 13A-D). Similar analysis can also be done for other materials and scenarios. For example, in the case of infrastructure projects like dams or nuclear plants that require mass concrete materials, it is important to consider the cementitious system in concrete. Portland cement is estimated to produce between 5% and 8% of global carbon dioxide (CO2) emission. H. Mikulčić, J. J. Klemeš, M. Vujanović, K. Urbaniec, and N. Duić, “Reducing greenhouse gasses emissions by fostering the deployment of alternative raw materials and energy sources in the cleaner cement manufacturing process,” Journal of cleaner production, vol. 136, pp. 119-132, 2016. It is also important to note that Portland cement amounts to between 68% and 79% of total CO2 emissions from concrete. A. Sharma, T. Sirotiak, M. L. Stone, X. Wang, and P. Taylor, “Effects of Cement Changes and Aggregate System on Mechanical Properties of Concrete,” Journal of Infrastructure Systems, vol. 27, no. 3, p. 04021012, 2021. To achieve various engineering properties of concrete, several additives are added into concrete. For mass concrete applications like dams, engineers try to avoid cracking due to thermal shrinkage from concrete. Thermal shrinkage is due to the exothermic nature of hydration reactions. This is a problem predominantly for thick concrete members like dams and culverts. One way of avoiding thermal shrinkage and resultant cracking is to partially replace some portions of Portland cement with supplementary materials like fly ash. Interestingly, typical replacement levels of Portland cement with fly ash results in a reduction of about 100-year GWP emissions by about 40%. A. Sharma, T. Sirotiak, M. L. Stone, X. Wang, and P. Taylor, “Effects of Cement Changes and Aggregate System on Mechanical Properties of Concrete,” Journal of Infrastructure Systems, vol. 27, no. 3, p. 04021012, 2021. Therefore, the carbon quantification tool described herein can be highly instrumental in making key decisions about concrete mix design etc.

One of the important aspects of this methodology is the consideration of 100-year GWP emissions from gas and diesel used during construction. Gas is associated with the commute of all personnel to and from work. Diesel is used in the operation of equipment and machinery during construction. Moreover, the emissions from fuel for powering the job site and all associated activities are also considered in this analysis within reasonable scope and boundaries. FIGS. 3A-3B show emissions due to materials and fuel in the case of another fictitious project comprising of a train station, published elsewhere. A. Sharma, P. Deka, G. Jois, U. Jois, and P. Tang, “Cradle to Gate Emissions Modeling for Scheduling of Construction Projects,” in ICCEPM 2022 The 9th International Conference on Construction Engineering and Project Management, Las Vegas, USA, 2022, pp. 975-983. In that example, two scenarios were considered: Scenarios 1 and 2 have total durations of NTP+18 months and NTP+28 months, respectively. It can be seen from FIG. 3A that although emissions from gas and diesel use are significantly lower than those from materials, the former cannot be ignored, nevertheless. One may find it hard to imagine that the total carbon emissions in a project can increase due to an increase in time. This is simply because of emissions due to fuel as shown in FIG. 3B, where Scenario 2's 100-year GWP from gas and diesel are higher than those in Scenario 1.

Due to the inclusion of detailed emissions at an activity level in a project schedule, this methodology allows the user to analyze emissions over time. FIGS. 7A-7D show the temporal distribution of GWP emissions for Scenarios 1 and 2 for the train station example discussed earlier. Scenario 1 in the collapsed Gantt chart in FIG. 7C shows that Phases III, IV and V overlap with Phase II, resulting in peaks of emissions which are visible on specific months (FIG. 7A). In contrast, the Gantt chart in FIG. 7D for Scenario 2 shows that there are no overlaps among any of the phases and therefore, the overall duration is 10 months longer than that in Scenario 1 (FIG. 7C). While the overall duration is longer in Scenario 2, the GWP emission peaks observed in Scenario 2 (FIG. 7B) are lower than those in Scenario 1 (FIG. 7A). The inclusion of different scenarios exemplifies the ability that this method provides the project controls personnel and construction managers with, of dynamically choosing between different relationships to achieve optimum GWP emission scenarios. Such relationship paths will help construction managers and owners make informed decisions about scenarios of potentially lower GWP emissions while also balancing duration and cost. Different state Departments of Environmental Protection usually target promoting sustainable construction practices and operations. While doing so, certain caps may be introduced on total carbon emissions at a given time. The temporal analysis can help ensure that such requirements are followed.

Another important advantage that this analysis at an activity level provides to the user is to be able to compare between planned baseline emissions and actual emissions at a given point of time. Based on these calculations, earned value type analysis can be performed. The following is one example of the kind of calculation that can be used for sustainability analysis:

$$Planned Sustainability ( {PS}_{u} ) = Total 100 - year GWP per approved baseline schedule$$

$$Acutal Sustainability ( {AS}_{u} ) = Actual 100 - year GWP as of data date$$

$$Sustainability Variance ( {S}_{u} V ) = {AS}_{u} - {PS}_{u}$$

As an example, for July 2022 in case of Scenario 1, PSᵤ=337×10\hat{ }3 GWP CO2-eq. Assuming that ASᵤ=350×10\hat{ }3 GWP CO2-eq. Therefore, SᵤV=350×10\hat{ }3−337×10\hat{ }3=13×10\hat{ }3 GWP CO2-eq.

It has been explained above that if the overall duration of a project increases, the GWP emissions associated with gas and diesel also contribute to a resultant increase in total GWP emissions. Specifically, the duration of activities like project management, quality assurance and control, maintaining power in the jobsite and trailer etc. (level of effort) will be increased if the overall project duration is increased. Consequently, the personnel involved in such LOE activities will continue commuting to work for longer durations than planned. As a result, the emissions from gas increase. Similarly, the longer power is maintained in the jobsite and trailer, higher GWP emissions are attributed to the project. Therefore, in case of LOE type activities, the GWP emissions are directly proportional to the duration. This is also because of a uniform distribution of GWP emissions for each day in case of these LOE activities. As a result of this uniform loading, the costs associated with the use of resources for extended periods of time are directly proportional to the GWP emissions.

It is generally understood that if there are changes either initiated by the owner or the contractor/design-builder in a project, the schedule may change with extensions of time. Generally, after negotiations are concluded between the owner and the contractor, a change order is awarded to the latter, therefore formalizing an extension of time in the schedule. The fragnets (i.e., fragmentary critical path networks) resulting out of such extensions will have an impact on the total GWP emissions associated with the project.

Currently, industry organizations like the Association for the Advancement of Cost Engineering International (AACEi) publish “recommended practices” for analyzing project delays, change management, and related topics. The system and method described herein can be used to define best practices and recommended practices to managing GWP, calculating SᵤV for change orders, and similar topics.

It is worth noting that significant delay events in a schedule may lead to additional GWP emissions in the form of LOE activities from commute of personnel, powering of offices and jobsites etc. Therefore, recovery schedules and mitigation measures should be carefully considered. In fact, acceleration measures in many cases require the use of additional resources and extended work shifts. This will most likely add additional GWP emissions even where the duration of a project may be reduced. Depending upon the scope of the project, a balance may have to be struck between cost, time, and sustainability. These considerations should be carefully deliberated while preparing specifications, contract documents and recommended best practices.

The two examples described herein can be classified as those in the infrastructure and transit industry. However, it should be noted that this methodology is versatile enough to be applied to project schedules in other industries as well. Examples of other industries include buildings, roads, oil and gas constructions, installations and operations, specialized construction, like data centers, train signal systems and automatic control etc. Some areas are explored further below.

Automated Train Control: With the intent of providing enhanced safety in railroads, various federal and regional transit agencies have resorted to different automated train control systems. These systems are aimed at replacing existing block or relay-based cab signaling systems with smarter train control systems. This requires that appropriate changes be made on the wayside, install radios and transponders, upgrade train cars with onboard computers with specialized software, and install a central back office that acts like a nerve center. Examples of such systems include positive train control (PTC), communications-based train control (CBTC) etc. These systems rely heavily on software which in turn relies upon milepost information etc. based on surveys of the railroad territories. As such software programs are highly specialized, in most cases multiple versions are released and deployed on the wayside, on-board and back-office systems. If the sustainability analysis methodology described herein is implemented in automated train control type projects, then special attention should be given in calculating emissions associated with software and hardware like servers. These operations can be heavily power intensive and may require operations across multiple teams located in different regions. Moreover, the efforts needed to make train control systems of one railroad interoperable with those of others needs to be carefully understood while defining scopes and boundaries and life cycle inventory (LCI).

Data Centers: Data centers are unique structures intended for specialized applications. These data centers house numerous servers and computing hardware. There is constant effort in developing and upgrading software to support various operations of the data centers. These data centers have a very high demand for electricity that can be provided through non-renewable (like thermal power) and renewable (like hydropower) sources. Moreover, data centers are also known to generate a high amount of electronic waste. These are important considerations while calculating the environmental impact of building and operations of such data centers.

Oil and Gas: The sustainability analysis method described herein is also applicable to the oil and gas industry. The Life Cycle Impact Assessment (LCIA) step in Life Cycle Assessment (LCA) described above also allows the user to calculate other metrics in addition to the effect on climate change, like eco-toxicity index etc. Depending upon the scope of a project in the oil and gas industry, the system boundaries and LCIA can be appropriately designed.

The embodiments disclosed above represent a new and improved technique of estimating greenhouse gas emissions impacting climate change, expressed as 100-year global warming potential (GWP) CO2-equivalent, at an activity level of a CPM schedule is presented. A discussion is also presented on the uses and applications of the methodology. The following are the key conclusions:
This methodology allows construction managers and contractors to explore alternative materials to reduce overall 100-year GWP emissions.
The 100-year GWP emissions from gas (from commute of personnel) and diesel (from equipment, power) need to be considered and not ignored.
Due to a temporal distribution of GWP emissions in lines with the schedule, construction managers and owners can make informed decisions about scenarios of potentially lower GWP emissions while also balancing duration and cost.
This methodology allows users to perform earned value type sustainability analysis (SᵤP).
Foe level of effort (LOE) type activities, there is a direct correlation between resources, cost, and 100-year GWP emissions.
Extension of time and change orders will have an impact on the total 100-year GWP of a project.
This methodology of sustainability analysis can be applied to different industries and projects.

### Optimization Techniques and Metaheuristics in Project Scheduling: Using Real-World Applications to Estimate Sustainability Metrics

Planning and scheduling form the backbone of project controls. Most construction projects rely heavily on a schedule model to plan the life cycle of the project from pre-construction to delivery. A critical path method (CPM) based schedule is governed by a set of backward and forward pass calculations that define the total duration of a project with a bottom-up approach. That means each activity has an assigned duration based on the type of work and is connected to other activities through different types of relationships. The critical path determines the minimum time needed to complete the scope of work associated with the project. Any attempts to reduce the overall duration and hence the critical path is typically dependent on the planning process, i.e., input information, historical knowledge, statistical data, etc., that result in the planned duration of individual activities. The planned duration of activities can be further refined by introducing the program evaluation and review technique (PERT). PERT is a statistical method which relies on a range of possible durations within a confidence interval to provide a more accurate estimation of the expected durations.

Another key aspect of CPM scheduling is the use of resources to perform the tasks represented in activities. Labor and non-labor type resources can be assigned to activities, units can be assigned in manhours, and cost can be calculated based on the unit price per hour. One of the key considerations of CPM and PERT is that resources are unlimited. Ö. H. Bettemir and R. Sonmez, “Hybrid genetic algorithm with simulated annealing for resource-constrained project scheduling,” Journal of Management in Engineering, vol. 31, no. 5, p. 04014082, 2015; M. Y. Cheng, D. H. Tran and Y. W. Wu, “Using a fuzzy clustering chaotic-based differential evolution with serial method to solve resource-constrained project scheduling problems,” Automation in Construction, vol. 37, pp. 88-97., 2014. Although commercial scheduling software like Oracle Primavera P6 and Microsoft Project have options for creating resource-dependent activities instead of task-dependent activities, the underlying algorithms do not provide any optimization techniques to reduce the duration of the schedule based on limited resources. However, resource limitations are common in the construction industry. For example, every contractor will have a fixed number of personnel and equipment when bidding for projects. Although additional personnel can be hired if needed, it is usually difficult to find personnel with the right skill sets. This is especially true post COVID-19 pandemic, which resulted in a labor shortage in the United States and other countries. Contractors also struggle to acquire or rent additional specialized equipment (like tunnel boring machine, excavator, backhoe etc.) for specific construction operations. This limitation of resources in various industries and its impact on schedule optimization is known as resource-constrained project scheduling problem (RCPSP), as studied by several researchers. J. Liu, Y. Liu, Y. Shi and J. Li, “Solving resource-constrained project scheduling problem via genetic algorithm,” Journal of Computing in Civil Engineering, vol. 34, no. 2, p. 04019055, 2020; S. Hartmann and D. Briskorn, “An updated survey of variants and extensions of the resource-constrained project scheduling problem,” European Journal of Operational Research, vol. 297, no. 1, pp. 1-14, 2022. Prior researchers have attempted to use optimization techniques like metaheuristics to reduce the total duration of a CPM schedule under an RCPSP.

Optimization techniques have been historically used in operational research and mathematics to optimize nondeterministic polynomial (NP) problems. NP problems are complex dependent variables (say y) that CANNOT be optimized to find a minimum or maximum value by using traditional primary and secondary derivatives of its function

$$( \frac{dy}{dx} , \frac{{d}^{2} y}{{dx}^{2}} ) .$$

Typically, these functions can be optimized for maximum or minimum values by trial-and-error method, which can be very time consuming for human calculations. Optimization techniques like heuristics and metaheuristics (higher-level heuristics) techniques are used to find the optimal or near-optimal maximum and minimum of such problems with the help of computer software. It is noted that the RCPSP problem is considered to be an NP problem, i.e., one will have to rely upon metaheuristics to find the minimum longest critical path duration under limited resources.

The project schedule is intended to be a holistic tool to model the life cycle of a project, as well as monitor the health of the project. In addition to the duration and dates of activities and key milestones, the schedule can also model the use of resources and resultant cost during the project. However, this tool can be made truly holistic by also tracking carbon emissions associated with the project. Jois Construction Management had developed a groundbreaking technique of integrating a CPM schedule with greenhouse gas emissions in terms of global warming potential (GWP) carbon dioxide equivalent (CO2-eq). A. S. Sharma, P. Deka, G. Jois and U. K. Jois, “Integrating Sustainability Metrics with CPM Schedules: A Novel Approach with Applications in the Construction Industry,” AACE International Transactions, pp. PS-4044, 2023; A. Sharma, P. Deka, G. Jois and U. Jois, “Life Cycle Assessment (LCA) of Activities in Project Schedule: Megaprojects,” in Project Controls Expo, Washington D.C., 2022; A. Sharma, P. Deka, G. Jois, U. Jois and P. Tang, “Cradle to Gate Emissions Modeling for Scheduling of Construction Projects,” in ICCEPM 2022 The 9th International Conference on Construction Engineering and Project Management, Las Vegas, 2022. This technique allows users to obtain earned value-type metrics to determine the environmental impact of the project's CO2-eq emissions, which is based on the life cycle assessment of the quantities of materials used. As a next step in this effort, the research team has explored the possibility of optimizing carbon emissions as a function of a CPM schedule in line with RCPSP optimization through metaheuristics.

Prior to applying the concepts identified herein, it is preferable that general scheduling practices should be adhered to so that the optimization of scheduling techniques can be introduced. These principles include developing the schedule to the required detail to support critical path methodologies. (The critical path can be determined by either using physical dependencies (the basement foundation needs to be poured before walls can be installed) or resource dependencies (Joe Smith completes task A before he can move on to task B). Project teams should endeavor to use physical dependencies to support the use of metaheuristics for RCPSP optimization.) Another principle is that PERT is also applied so that the expected durations are identified. This approach solidifies the understanding of critical and near-critical activities. Once complete, it is expected that the correct resources and their level of effort are assigned to their respective activities. The final step is to understand resource usage and identify resource overload. Opportunities to level resources to eliminate overload are required to ensure that the schedule provides the most realistic and achievable plan.

Once these activities for schedule development are complete, the project teams should validate the overall plan to ensure that the best schedule is brought forward. After these steps are completed, the project team can introduce the methods described herein, which allows the team to explore the possibility of further optimizing the schedule for RCPSP problem (i.e., by using metaheuristics like Genetic Algorithms, utilizing forward-backward improvement, etc.). These steps provide the segway to further define functions of carbon footprint of a project for potential algorithmic optimization.

### Heuristics and Metaheuristics:

Metaheuristics are algorithms used to optimize complex NP type problems to find optimal or near-optimal solutions. They can be considered advanced versions of heuristic algorithms, some of which are embedded in commercial scheduling software like Oracle Primavera P6 and Microsoft Project. J. Liu, Y. Liu, Y. Shi, and J. Li, “Solving resource-constrained project scheduling problem via genetic algorithm,” Journal of Computing in Civil Engineering, vol. 34, no. 2, p. 04019055, 2020. An important aspect of heuristics related to the CPM schedule is the schedule generation scheme (SGS), which can be activity-oriented serial SGS, or time-oriented parallel SGS. (A Schedule Generation Scheme (SGS) is the assigning of start dates and times to activities, either in sequence or in parallel, to develop a feasible project schedule (M. Vanhoucke, 2012, PM Knowledge Center https://www.pmknowledgecenter.com/dynamic_scheduling/baseline/optimizing-regular-scheduling-objectives-schedule-generation-schemes.) SGS is used to optimize a schedule based on a forward-backward improvement (FBI). In other words, forward pass and backward pass calculations are conducted on several iterations of changes in the sequence of activities and their relationships to reduce the overall duration of the schedule.

Prior researchers have more commonly used metaheuristics to optimize schedules under resource constraints. Metaheuristics can be population-based (algorithms that use a set of potential solutions as the search space) like genetic algorithm (GA), particle swarm optimization (PSO), etc., or neighborhood search-based (algorithms that rely upon local solutions), like simulated annealing (SA). Metaheuristics, like GA and ant colony optimization (ACO), are inspired by nature. Simulated annealing (SA), on the other hand, is based on the metallurgical process of heating a metal to high temperatures and then cooling it. For solving the RCPSP problem, an overwhelming majority of prior researchers have used GA. A. Golab, E. Gooya, A. Falou and M. Cabon, “Review of conventional metaheuristic techniques for resource-constrained project scheduling problem,” Journal of Project Management, vol. 7, no. 2, pp. 95-110, 2022. One reason for this approach could be due to the crossover and mutation functionalities of GA, which fit well with a need to re-organize predecessors of activities over a horizontal axis of time.

A key first step in optimization through metaheuristics techniques is to define a function accurately. For RCPSP, such functions are well-defined by prior researchers. J. Liu, Y. Liu, Y. Shi and J. Li, “Solving resource-constrained project scheduling problem via genetic algorithm,” Journal of Computing in Civil Engineering, vol. 34, no. 2, p. 04019055, 2020; B. Roy and A. K. Sen, “Meta-heuristic techniques to solve resource-constrained project scheduling problem,” in International Conference on Innovative Computing and Communications: Proceedings of ICICC 2018. Springer, Singapore, 2019. The minimum overall duration of a project is a function of precedence relationships and resource constraints within defined time periods. However, such functions need to be defined to optimize carbon emissions associated with activities in a project schedule.

Genetic Algorithm: Genetic algorithms (GA) were developed by John Holland based on principles of genetics and natural selection. A. H. Gandomi, X. S. Yang, S. Talatahari and A. H. Alavi, “Metaheuristic algorithms in modeling and optimization.,” Metaheuristic applications in structures and infrastructures, vol. 1, pp. 1-24, 2013. This method inspired by nature is a population-based search tool for finding the optimal or near optimal solution. GA are designed to select the best solution for a specific problem and optimize the process studied. The main operators of GA are genetic crossover, mutation, and selection. For the examples described herein, genetic crossover operator will be used. Crossover operators could be single, double, or multi-point. Genetic operators provide the basic search mechanism of the GA and are used to create new solutions based on existing solutions in the population by finding the optimum or near-optimum minimum or maximum of a function. Some key aspects of GA that are applicable to the embodiments described herein are explained in this section.

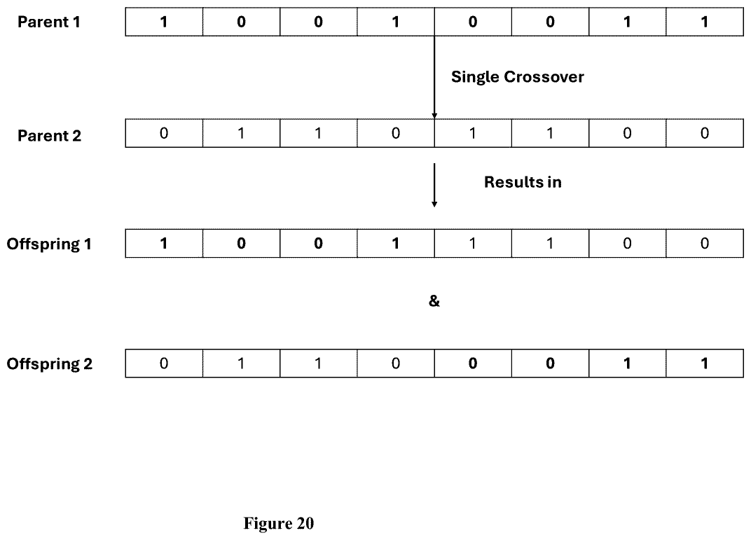

In order to perform this type of metaheuristic, a few solutions of the intended function are selected at random, out of which, based on a certain criterion, two best solutions are selected and named Parent 1 and Parent 2. These are represented in terms of chromosomes consisting of a few binary digits, as shown in FIG. 20. The example shown in FIG. 20 shows two offspring being generated by performing a single crossover between parent 1 and parent 2. Single-point cross-over is a technique where the selected parent population is cut at a randomly selected location, called the pivot point or cross-over point. The resultant offspring 1 and offspring 2 have different bits in their chromosomes compared to their parents. The genetic information to the left (or right) of the point is swapped between the two parent chromosomes to produce two offspring chromosomes. This process is repeated until an optimal or near-optimal solution is achieved. It should be noted that the function to be optimized by using this technique should generally be defined accurately. This step is of utmost importance because a near-optimum minimum cannot be found without defining all the independent variables of a function.

Genetic Algorithm for Schedule Optimization: Prior researchers have utilized GA to reduce the overall duration or find a minimum duration under fixed resources. The following is an explanation of the resource-constrained project scheduling problem (RCPSP) defined by Christofides et al. and adapted by Liu et al. J. Liu, Y. Liu, Y. Shi and J. Li, “Solving resource-constrained project scheduling problem via genetic algorithm,” Journal of Computing in Civil Engineering, vol. 34, no. 2, p. 04019055, 2020; N. Christofides, R. Alvarez-Valdés and J. M. Tamarit, “Project scheduling with resource constraints: A branch and bound approach,” European journal of operational research, vol. 29, no. 3, pp. 262-273, 1987.
A project can be defined by a series of activities V={1, 2, 3, . . . , J).
If i is an activity in this set, i.e., i∈V, then rᵢₖ is the constant required resource type k for activity i.
The goal is to minimize the overall duration of the project, i.e., min Fⱼ.
Rₖ is the available resource k per day.
The first and last activities, 1 and J are dummy activities with duration d₁=d_{J}=0.
Moreover, these dummy activities will consume no resources, i.e., r₁ₖ=r_{Jk}=0.
If Pᵢ is the set of all predecessor activities to activity i, and predecessor h∈Pᵢ, then a key rule is that all predecessor activities have to be completed before activity i can start. i.e., Fₕ≤Fᵢ−dᵢ, where i=2, 3, . . . J.

Another key rule is the total amount of resource type k that is required for all activities at any given time cannot exceed Rₖ, i.e., Σᵢ₌₁^{J}rᵢₖ≤Rₓ, where k∈K.

After the function and constraints are defined, crossover techniques can be applied as FBI to optimize the overall duration of the project. The following is a simplified explanation of the FBI approach to optimize the overall duration of the schedule.

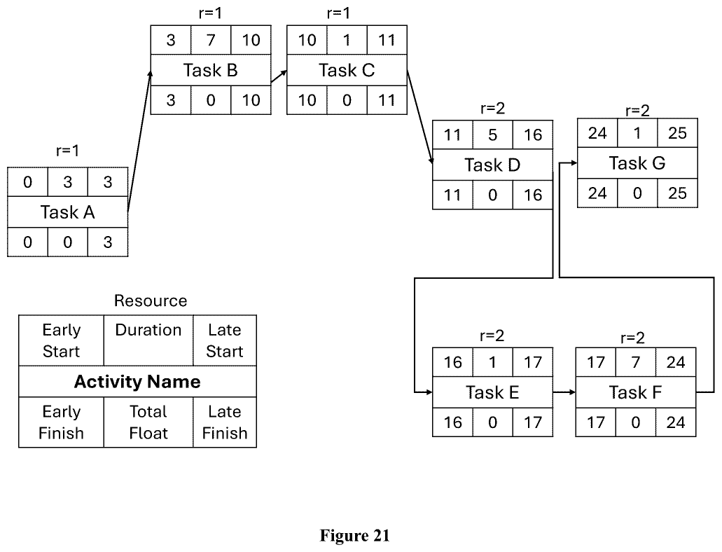

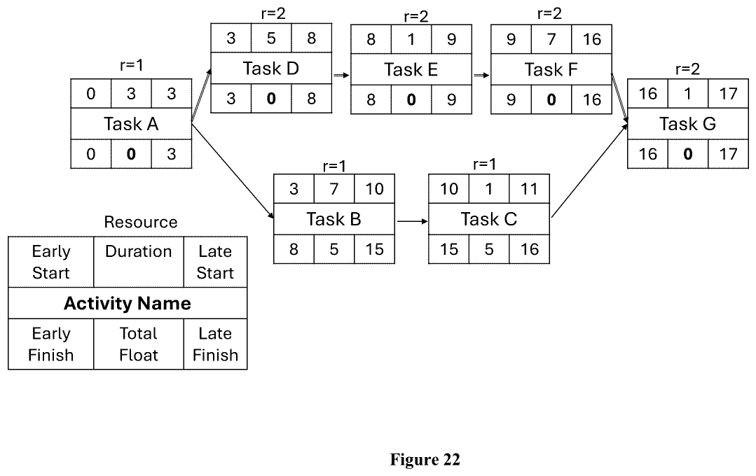

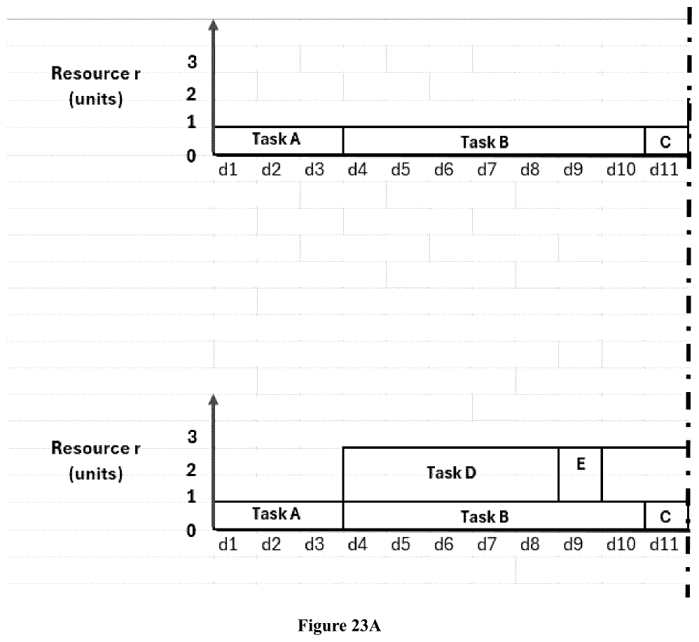

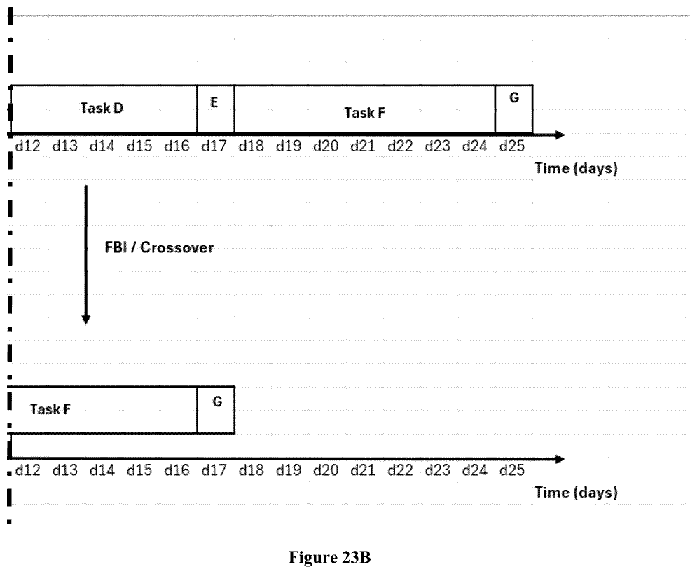

FIG. 21 shows the network diagram of an example project. The project consists of 7 activities. The available resource per day, R is 3 k type resources. The number of resources r, needed for each activity is listed on top of each activity in the precedence diagram. The duration d, of each activity is listed in the top center box of each activity. The overall duration of the project comes out to be 25 days. In FIG. 22, some of the activities are shown to be done in parallel to others. Therefore, the sequence of activities is modified to obtain a schedule with a shorter overall duration. FIGS. 23A-23B show that within the allowed resources per day, the sequence of the activities could be changed to complete the project within 17 days instead of 25 days. For more complex schedules, several iterations may be required to accomplish an optimal or near-optimal minimum overall duration.

A key takeaway from the simplified example demonstrated above of GA on RCPSP is that optimization of schedule duration involves changes in the sequence of activities, i.e., predecessors and successors of activities with an assumed relationship type of finish-to-start with no lag. The crossover operator of GA helps visualize the re-organization of activities on a resource-time plane, as shown in FIGS. 23A-23B. However, this may not necessarily be the best method to optimize carbon emissions associated with activities in a schedule.

The embodiments disclosed herein represent a new method of integrating greenhouse gas emissions into a critical path method (CPM) based schedule. The method was presented in detail previously at the AACE Conference in Chicago in 2023. A. S. Sharma, P. Deka, G. Jois and U. K. Jois, “Integrating Sustainability Metrics with CPM Schedules: A Novel Approach with Applications in the Construction Industry,” AACE International Transactions, pp. PS-4044, 2023. In this method, the environmental emissions associated with each activity of a CPM schedule can be estimated in terms of 100-year GWP CO2-eq. CO2 is the most dominant greenhouse gas (GHG). These emissions are mainly contributed by the embodied carbon of the materials in use in a particular activity, as well as the use of resources, associated fuel used, etc. (By suitably modifying the system boundaries of a cradle-to-gate LCA method, the GWP emissions of the transportation (of materials) to the job site are grouped with the material category. Any other emissions due to internal transport are captured under fuel used by equipment. Any wastage in materials and, therefore, the use of equipment and resultant fuel will be considered in the as-built calculations offered by this method.) Moreover, earned value type analysis can be performed by a sustainability variance, which is the difference between actual emissions and planned emissions for a particular period. This tool will provide an avenue for owners/agencies and construction managers to make informed decisions to balance schedule, cost, and environmental sustainability.

Before finalizing a method of optimization, it is important to define an accurate function for the carbon footprint of a project. For an activity i∈V, where V is the set of all activities in the schedule, 100-year GWP CO2-eq can be defined as eᵢ=F(Σₗ₌₁^{x}mᵢₗ, Σ_{g=1}^{y}fl_{ig},dᵢ,Cᵢ), i.e., that eᵢ is a function of
The sum of 100-year CO2-eq due to embodied carbon of materials, m, having types I={1, 2, 3, . . . , x} used in activity i;
The sum of 100-year CO2-eq due to fuel used, fl, having types g={1, 2, 3, . . . , y} used in activity i;
Duration d of activity i;
Complexity of work for activity i.

Embodied Carbon of Materials: The type of materials used in an activity of a schedule can have a huge impact on the carbon emissions associated with the activity. Common construction materials like concrete, steel, asphalt, and glass are heavy contributors to global greenhouse gas emissions, so much so that several agencies are trying to focus on the impact of these materials. The manufacturing process of such materials is carbon intensive. Embodied carbon of a material is the accumulation of carbon emissions associated with raw material acquisition, preparation and handling, manufacturing/production, packaging, and transportation. The embodied carbon of materials used in an activity, as well as in the entire project, contributes to the bulk of the emissions associated with that activity or the project. A. S. Sharma, P. Deka, G. Jois and U. K. Jois, “Integrating Sustainability Metrics with CPM Schedules: A Novel Approach with Applications in the Construction Industry,” AACE International Transactions, pp. PS-4044, 2023; A. Sharma, P. Deka, G. Jois and U. Jois, “Life Cycle Assessment (LCA) of Activities in Project Schedule: Megaprojects,” in Project Controls Expo, Washington D.C., 2022.

Therefore, quantification of emissions due to materials is of utmost importance. A key precursor to the quantification of emissions of materials is an accurate quantity take-off at an activity level of the schedule. For example, one should be able to quantify the amount of concrete used in pouring a footing, as opposed to the total quantity of concrete to be used during the entire project. Based on this activity level quantity take-off, the resultant emissions can be estimated by performing a life cycle assessment (LCA) on the type of concrete. Another important aspect of the method developed by this group is the consideration of alternative materials. The user can compare different materials and select the least carbon-intensive materials. After a choice has been made on materials based on engineering requirements, other aspects like costs and procurement durations will have to be considered.

Emissions Due to Fuel: The resources used in an activity contribute to GWP emissions by the consumption of fuel used. The equipment used during various activities of the schedule can be identified, and the hours of operations can be calculated. The use of equipment will lead to fuel consumption and resultant emissions. Similarly, the commute of personnel in the project and at an activity level will result in carbon emissions. These emissions are significant enough not to be ignored in one's carbon estimates. The use of electricity in the job site and offices can also be equated to different types of fuel consumed based on the area's grid and power sources. All these emissions due to various types of fuel will determine the emissions associated with an activity.

Effect of Duration: The duration of an activity has an impact on the resultant emissions of the project. Direct labor applicable to extended durations may contribute to the carbon footprint. Moreover, level of effort (LOE) type activities will also have an impact. In case of delays, all LOE tasks like project management, site supervision, etc., can contribute to an increase in GWP emissions over the duration of the delay. This becomes more significant in the case of change orders and extension of time execution, where negotiations can take a long time.

Complexity of Work: The emissions associated with an activity or a project will also depend on the complexity or nature of the work to be performed. In the case of relatively simple and repeatable work like pouring concrete on a sidewalk, installing steel rebar in a column, etc., contractors have a lot of experience and historical knowledge. Moreover, the availability of personnel equipped with such skills will be high. Therefore, in case of unforeseen circumstances involving personnel or equipment, the contractors can still maintain redundancy and complete the work without any significant changes in duration and resources. However, if the work to be performed is highly specialized, like excavation through a tunnel boring machine (TBM), any breakdowns of machinery may have a significant impact on the at-completion-duration of the activity. Moreover, the replacement of such specialized equipment will pose a significant challenge, and any replacement may have hugely different fuel consumption rates, etc. Another aspect is the nature of the function to be performed. It is widely known that tasks requiring software development, functions testing, and validation can be very challenging as the probability of finding issues is high, especially on train and bus control systems. Moreover, the reliance on data centers may have some implications on environmental emissions.

It is clear that any attempts to find an optimal or near-optimal minimum of GWP emissions in a CPM schedule will likely involve other analytical methods. One way to start is by optimizing the schedule by GA of RCPSP. The next step will be to optimize the cumulative GWP emissions in the schedule. However, it cannot be established whether the defined emissions function is truly NP-type (as noted earlier). It is challenging to validate this function and its dependencies due to a lack of historical information on GWP emissions associated with a CPM schedule. However, as federal and state agencies start to implement sustainability measures into construction projects, much-needed data will emerge, and eventually, the function described herein can be validated. This will also facilitate accurate characterization of a categorical variable like the complexity of work. In other words, something like how technically challenging a type of activity is, may be difficult to quantify. Therefore, its impact on GWP emissions can be difficult to predict without validation with field data.

The following are the key conclusions based on the disclosure herein:
Metaheuristics are used to optimize non-deterministic polynomial (NP) problems.
Resource constrained project scheduling problem (RCPSP) has been mainly optimized by using genetic algorithm (GA) by prior researchers.
The overall duration of a schedule is reduced by crossover operator of GA and forward-backward Initiative (FBI), resulting in changes in predecessors and successors of activities.
The GWP CO2-eq of each activity in a schedule is a function of the embodied carbon of different types of materials used, fuel used by resources, the duration of the activity, and the complexity and nature of work involved.
The optimization of GWP emissions as a function of a CPM schedule can be performed after enough data is generated, provided federal and state agencies implement sustainability metrics on construction projects.

1. An improvement to the way that computer systems operate using a critical path method (CPM) schedule to allow a user to schedule a construction project having one or more phases based on dates and durations of construction activities, interdependencies among the construction activities, and milestones associated with the construction project, the improvement comprising a computer-implemented CPM scheduling method that integrates carbon emissions associated with the activities and permitting a user to schedule the project and integrate the carbon emissions of the construction activities, comprising:
a. storing, by said computer system, information regarding one or more milestones associated with the construction project;
b. storing, by said computer system, information regarding one or more phases associated with the construction project;
c. storing, by said computer system, information regarding one or more construction activities associated with the construction project, wherein said construction activity information includes:
i. interdependency information associated with the construction activity, and
ii. carbon emissions information associated with the construction activity;
d. calculating, based on said construction project milestone information, said construction project phase information, and said construction activity information, one or more of:
i. a schedule of said construction project;
ii. an identity of one or more key construction activities;
iii. duration information associated with said key construction activity;
iv. date information associated with said key construction activity;
v. total carbon emission information associated with said key construction activity;
vi. duration information associated with said phase;
vii. date information associated with said phase;
viii. total carbon emission information associated with said phase;
ix. date information associated with said milestone; and
x. total carbon emission information associated with said milestone.

2. The method of claim 1 wherein the critical path method (CPM) schedule further allows the user to schedule the construction project based on resources, materials, and costs associated with the construction activities, wherein:
a. said storing step further includes:
i. resource information associated with the construction activity;
ii. cost information associated with the construction activity; and
iii. material information associated with the construction activity; and
b. said calculating step further includes calculating one or more of:
i. resource information associated with said key construction activity, said phase, and said milestone;
ii. cost information associated with said key construction activity, said phase, and said milestone; and
iii. material information associated with said key construction activity, said phase, and said milestone.

3. The method of claim 1 wherein said carbon emissions information associated with the construction activity is a metric that reflects the environmental impact of the construction activity.

4. The method of claim 3 wherein said metric is 100-year CO2-equivalent Global Warming Potential.

5. The method of claim 1 further including the steps of:
a. storing industry standard environmental information relating to the construction project; and
b. comparing said industry standard environmental information to one or more of said total carbon emission information associated with said key construction activity, total carbon emission information associated with said phase, and total carbon emission information associated with said milestone.

6. The method of claim 5 wherein the industry standard is one or more of a standard promulgated by a government entity, an industry organization, or an advisory body.

7. The method of claim 1 further including the step of calculating total carbon emission information as a function of the date.

8. The method of claim 2 wherein the resource information associated with the construction activity includes one or more of staff and energy use.

9. The method of claim 8 wherein said carbon emissions information associated with the construction activity includes information associated with said staff's commutation distance and mode of transport.

10. The method of claim 9 wherein said carbon emissions information associated with the construction activity includes information associated with energy use of level-of-effort activities.

11. The method of claim 1 wherein said carbon emissions information associated with the construction activity includes information associated with the materials used in said construction activity.

12. The method of claim 1 wherein said carbon emissions information associated with the construction activity includes information associated with energy use of equipment.

13. The method of claim 7 further including the steps of:
a. proceeding with said schedule of said construction project, including performing one or more planned construction activities;
b. calculating, as of a date on said schedule, total carbon emission information based on said planned construction activity;
c. measuring, for an actual construction activity, one or more of duration information associated with said actual construction activity and date information associated with said actual construction activity;
d. calculating, based on said construction activity information and said measured date and duration information, total carbon emission information associated with said actual construction activity as of said date on said schedule;
e. calculating a sustainability variance equal to the difference between said total carbon emission information based on said planned construction activity and said total carbon emission information associated with said actual construction activity.

14. The method of claim 13 further including the step of optimizing sustainability by calculating, based on said sustainability variance, said construction project milestone information, said construction project phase information, and said construction activity information, an optimized schedule for said construction project.

15. An improved computer system that operates using a critical path method (CPM) schedule to allow a user to schedule a construction project having one or more phases based on dates and durations of construction activities, interdependencies among the construction activities, and milestones associated with the construction project, the improvement comprising a computer-implemented CPM scheduling system that operates to integrate carbon emissions associated with the activities and permits a user to schedule the project and integrate the carbon emissions of the construction activities, comprising:
a computer system having a memory and a processor;
a computer program stored in said memory and adapted to run on said processor, configured to:
a. store, in said memory, information regarding one or more milestones associated with the construction project;
b. store, in said memory, information regarding one or more phases associated with the construction project;
c. store, in said memory, information regarding one or more construction activities associated with the construction project, wherein said construction activity information includes:
i. interdependency information associated with the construction activity, and
ii. carbon emissions information associated with the construction activity;
d. calculate, by said processor, based on said construction project milestone information, said construction project phase information, and said construction activity information, one or more of:
i. a schedule of said construction project;
ii. an identity of one or more key construction activities;
iii. duration information associated with said key construction activity;
iv. date information associated with said key construction activity;
v. total carbon emission information associated with said key construction activity;
vi. duration information associated with said phase;
vii. date information associated with said phase;
viii. total carbon emission information associated with said phase;
ix. date information associated with said milestone; and
x. total carbon emission information associated with said milestone.

16. The system of claim 15 wherein the critical path method (CPM) schedule further allows the user to schedule the construction project based on resources, materials, and costs associated with the construction activities, wherein said computer program is further configured to:
a. store, in said memory, further information regarding one or more construction activities associated with the construction project, including:
i. resource information associated with the construction activity;
ii. cost information associated with the construction activity; and
iii. material information associated with the construction activity; and
b. calculate, by said processor, one or more of:
i. resource information associated with said key construction activity, said phase, and said milestone;
ii. cost information associated with said key construction activity, said phase, and said milestone; and
iii. material information associated with said key construction activity, said phase, and said milestone.

17. The system of claim 15 wherein said carbon emissions information associated with the construction activity is a metric that reflects the environmental impact of the construction activity.

18. The system of claim 17 wherein said metric is 100-year CO2-equivalent Global Warming Potential.

19. The system of claim 15 wherein said computer program is further configured to:
a. store, in said memory, industry standard environmental information relating to the construction project; and
b. compare, by said processor, said industry standard environmental information to one or more of said total carbon emission information associated with said key construction activity, total carbon emission information associated with said phase, and total carbon emission information associated with said milestone.

20. The system of claim 19 wherein the industry standard is one or more of a standard promulgated by a government entity, an industry organization, or an advisory body.

21. The system of claim 15 wherein said computer program is further configured to calculate, by said processor, total carbon emission information as a function of the date.

22. The system of claim 16 wherein the resource information associated with the construction activity includes one or more of staff and energy use.

23. The system of claim 22 wherein said carbon emissions information associated with the construction activity includes information associated with said staff's commutation distance and mode of transport.

24. The system of claim 23 wherein said carbon emissions information associated with the construction activity includes information associated with energy use of level-of-effort activities.

25. The system of claim 15 wherein said carbon emissions information associated with the construction activity includes information associated with the materials used in said construction activity.

26. The system of claim 15 wherein said carbon emissions information associated with the construction activity includes information associated with energy use of equipment.

27. The system of claim 21 wherein said computer system is further configured to:
a. store, in said memory, information relating to proceeding with said schedule of said construction project, including information relating to performing of one or more planned construction activities;
b. calculate, by said processor, as of a date on said schedule, total carbon emission information based on said planned construction activity;
c. store, in said memory, measurements, for an actual construction activity, of one or more of duration information associated with said actual construction activity and date information associated with said actual construction activity;
d. calculate, by said processor, based on said construction activity information and said measured date and duration information, total carbon emission information associated with said actual construction activity as of said date on said schedule;
e. calculate, by said processor, a sustainability variance equal to the difference between said total carbon emission information based on said planned construction activity and said total carbon emission information associated with said actual construction activity.

28. The system of claim 27 wherein said computer system is further configured to optimize sustainability by calculating, by said processor, based on said sustainability variance, said construction project milestone information, said construction project phase information, and said construction activity information, an optimized schedule for said construction project.
